(19) United States
(12) Patent Application Publication
(10) Pub. No.: US 2014/0058705 A1
(43) Pub. Date: Feb. 27, 2014

(54) System and Method for Detecting Abnormal Occurrences

(71) Applicant: Eyal Brill, Shoham (IL)

(72) Inventor: Eyal Brill, Shoham (IL)

(73) Assignees: DECISION MAKERS LTD., Shoham (IL); WHITEWATER TECHNOLOGIES LTD., Tel Aviv (IL)

(21) Appl. No.: 14/113,669

(22) PCT Filed: Apr. 24, 2012
(86) PCT No.: PCT/IL2012/000168

§ 371 Date: Oct. 24, 2013

Related U.S. Application Data
(60) Provisional application No. 61/479,668, filed on Apr. 27, 2011.
(60) Provisional application No. 61/539,212, filed on Sep. 26, 2011.

(51) Int. Cl. G01N 35/00

(52) U.S. Cl. CPC G01N 35/00
USPC 702/183

(57) ABSTRACT

An abnormal-occurrence-detection-system comprising an abnormal-occurrence-detector inspecting a plurality of inspected-data-instances, each data-instance including values associated with at least one physical-attribute, the values defining the location of each data-instance in an attribute-space, the abnormal-occurrence-detector detecting when at least one data-instance corresponds to an abnormal-occurrence according to one of the following: when a density-point associated with one of the inspected-data-instances is not associated with at least one hilltop-point, and when the distance in the attribute-space, between a selected one of the inspected-data-instances associated with a first respective unique-identifier in a sorted list of unique-identifiers and a respective K^{th} adjacent inspected-data-instance associated with a second respective unique-identifier in the sorted list of unique-identifiers, exceeds a distance-threshold-for-K^{th}-adjacency, the sorted list of unique-identifiers defining a sorted sequence of data-instances, the respective K^{th} adjacent inspected-data-instances being K entries away from the selected one inspected-data-instance in the sorted sequence of data-instances, and a database coupled with the event-detector, for storing data-instances.

### FIELD OF THE DISCLOSED TECHNIQUE

The disclosed technique relates to data analysis, in general, and to methods and systems for detecting occurrences, in particular.

### BACKGROUND OF THE DISCLOSED TECHNIQUE

Analysis of measured data enables the detection monitoring and management of occurrences. For example, in a water supply system, the contamination of a water reservoir is an abnormal occurrence that can be detected and monitored. Failure of distribution lines, transformers, solar panels and the like are also abnormal occurrences that may be detected. Detection of occurrences requires the classification of real-time data measurements as either a frequent occurrence or an abnormal occurrence. The abnormal occurrences are reported to the operators of the supply system.

U.S. Pat. No. 7,866,204 to Yang et al, entitled “Adaptive real-time contaminant detection and early warning for drinking water distribution systems” directs to adaptive techniques and algorithms for real-time contaminant detection in drinking water distribution systems. According to the techniques to Yang et al in a first step, baseline values for water components in the distribution system at a particular local monitoring station are determined. Step two includes determining the presence of a contaminant chemical component or an aberrant concentration of a chemical component of the water at that local monitoring station or water plant. In step three the contaminant chemical or aberrant concentration or determining the location within the water distribution system are identified. In the first step, sensor measurements are adaptively transformed to sensor response ratios and sanitized for gross outlier identification. The adaptive transformation follows the least-square local polynomial regression (LSLPR) techniques in a moving time window. It is aimed to classify new measurement data, detect change points and anomalies. Time window in the LSLPR analysis is kept dynamic. The output from step-one includes determining whether the incoming data pair is an anomaly, background baseline, or a data outlier of unknown origin. In the case of non-detection, the data are registered in a baseline database and background data abstraction is updated. Analysis for outlier and anomaly detections is then preceded in Step-Two. According to Yang et al, drinking water in a distribution pipe network contains disinfectants such as free chlorine, an oxidant that is a principal component of household bleach. The disinfectants and other water-born chemicals react with introduced contaminants producing a suite of characteristic sensor responses. When assembled in patterns, unique patterns frequently result, which allows the responses to be used to confirm the detections and to infer contaminant classes or even specific compounds. If inter-parameter relationship does not qualify for contaminant detection, the transformed sensor data pair is classified as a part of the background baseline variations. When the detection is confirmed, a sensor sampling schedule is then modified adaptively. Further according to Yang et al, two paired sensor locations are configured along the same water flow path. These two sensors detect the motion of contaminants in a form of slug along with the bulk water. In the third step, the output of two paired sensors is examined. Once a slug of contaminants is detected, then real-time early warning can be generated and communicated. When detection is not confirmed, the data pair is re-classified and used to update baseline in data abstraction.

In general, a data measurement are stored in a database (i.e., each measurement is an entry in the database) and may include the measurement of a plurality of attributes. For example, measurements of electric characteristics of an electricity distribution system may include attributes such as electric current, voltage, phase, frequency, location in the network and the like. In general, the plurality of attributes may be regarded as a multi-dimensional space (i.e., each sensor corresponds to one dimension) and the data entries in the database can be regarded as points in this multi-dimensional space. The points in the multi-dimensional space are also referred to herein as ‘data points’ or ‘points’. The multi-dimensional attribute space may not be uniformly occupied by the data points. Certain regions of the attribute space may dense while other regions may be sparse. The dense regions may be regarded as a subset or subsets of data entries, which exhibit at least one similar attribute, the similar attribute being determined according to a similarity or dissimilarity criterion or criteria. For example, all the entries exhibiting a selected attribute or selected attributes within a determined range may be regarded as similar entries. Accordingly, the dense regions in the attribute space can be regarded as subsets of data entries, which exhibit similar attributes (e.g., according to a similarity criterion). Continuing with the example of an electricity distribution system, the following data entries may be regarded as similar data entries: the current attribute exhibiting values between 10 and 20 Amperes, the voltage attribute exhibiting values between 230 and 250 Volts, the phase attribute exhibiting values between −5 radians to +5 radians and the frequency attribute exhibiting values between 58 and 62 Hertz.

Prior to classification of real-time measurement, analysis of prior measured data is performed to determine the partition data entries in the database into subsets, according to similarity criteria. The members of these subsets may be classified as normal occurrences. A real-time measurement, which is determined to be associated to one of these subsets (i.e., according to the similarity criterion) is classified a normal occurrence. When a real-time data measurement is determined not to be associated with any one of the subsets, then that data measurement is classified an abnormal occurrence.

Clustering methods attempt to partition the data entries into subsets, according to selected similarity criteria. In the attribute space, these subsets can be visualized as clusters of data points. Some prior art clustering techniques are based on an estimation of a density function of the data points in the attributes space. The book by Jain Anil K. and Dubes Richard C. “Clustering Methods and Algorithms”, Prentice Hall 1988 presents a clustering method in which clusters are identified by searching for regions of high densities, which are referred to as modes. Each mode is associated with a cluster center and each point is assigned to a cluster with the closest center. Anil et al. further describes a simple way to identify modes by partitioning the attribute space into non-overlapping cells and determining a histogram (i.e., determining the number of data points in each cell). Cells with relatively high frequency counts are potential cluster centers. The boundaries between clusters fall in the valleys of the histogram.

The Publication by Alexander Hinneburg and Hans-Henning Gabriel “DENCLUE 2.0: Fast Clustering Based on Kernel Density Estimation”, Intelligent Data Analysis (IDA) 2007, pages 70-80 directs to a clustering algorithm in which the probability density in the attribute space is estimated as a function of all data points. The influence of each point is modeled with a Gaussian Kernel. The sum of all kernels gives an estimate of the probability at a given point. A cluster is defined as a local maximum of the estimated density function. A hill-climbing procedure assigns each data point to a respective local maximum. The hill-climbing procedure starts at a data point and iterates until the density does not grow anymore.

A Random Walk (RW) is a mathematical formalization of a trajectory. The trajectory consists of a sequence of discrete steps, where the direction and size of each step is random and does not depend on the previous steps. RW is an abstraction for a range of processes observed in all sorts of complex systems. For example, random Brownian motion of molecules in liquids and the foraging behaviour of animals and insects may be represented by RWs. A Gaussian RW is a RW process in which the step size varies according to a normal distribution (i.e., and the step direction is random). More generally, a distributional RW is a RW in which the step size is determined according to a known distribution, such as Gaussian distribution or Poisson distribution.

Distance based approaches for detecting anomalies and employing RW distance based metric, are known in the art. The Publication by Nguyen Lu Dang et al. “Network Anomaly Detection Using a Commute distance Based Approach”, published in ICDMW '10 Proceedings of the 2010 IEEE International Conference on Data Mining Workshops, is directed to a distance based method for detecting anomalies in computer network traffic using commute distance. Commute distance is a measure derived from random walk on graph. Random walk on graph is a stochastic process in which the next vertex in the trajectory is randomly selected from the neighbors of the current vertex. The commute distance is the number of random walk steps it takes for reaching from a first vertex to a second vertex and back. The anomaly detection method includes the steps of constructing a mutual K₁ nearest neighbor graph from a dataset, calculating the pair-wise commute distance between any two observations of the dataset, and detecting the top N anomalies by employing a designated pruning technique.

### SUMMARY OF THE PRESENT DISCLOSED TECHNIQUE

It is an object of the disclosed technique to provide a novel method and system for detecting abnormal occurrences. In accordance with the disclosed technique, there is thus provided an abnormal occurrence detection system. The system comprises an abnormal occurrence detector and a database coupled thereto. The abnormal occurrence detector inspects a plurality of inspected data instances, each one including values associated with at least one physical attribute. The physical attributes define the location of each data instance in an attribute space. Some of the dimensions of the attribute space are each associated with respective one of physical attributes. The abnormal occurrence detector detects when at least one data instance corresponds to an abnormal occurrence according to at least one of the following:
when a density point associated with one of the inspected data instances is not associated with a hilltop point. The density point is defined as a location in the attribute space, associated with a value representing the number of analyzed data instances in a predefined area around that location. The at least one hilltop point is defined at least when the density value of a density point, is larger than the density values of density points at most a predetermined distance from said density point, by a predetermined value; and
when the distance in said attribute space, between a selected one of inspected data instance associated with a first respective unique identifier in a sorted list of unique identifiers and a respective K^{th} adjacent inspected data instance associated with a second respective unique identifier in the sorted list of unique identifiers, exceeds a distance threshold for K^{th} adjacency. The sorted list of unique identifiers define a sorted sequence of data instances. The respective K^{th} adjacent inspected data instance is K entries away from said selected inspected data instance in thesorted sequence of data instances.
   The database stores the data instances.

In accordance with another aspect of the disclosed technique, there is thus provided a method for detecting abnormal occurrences. The method includes the procedure of acquiring a plurality of inspected data instances. Each inspected data instance includes values associated with at least one physical attribute. These values defining the location of each data instance in an attribute space. Some of the dimensions of the attribute space being each associated with respective physical attribute. The method further includes the procedure of detecting when at least one data instance corresponds to an abnormal occurrence according to at least one of the following:
when a density point associated with one of the inspected data instances is not associated with a hilltop point. The density point is defined as a location in the attribute space, associated with a value representing the number of analyzed data instances in a predefined area around that location. The at least one hilltop point is defined at least when the density value of a density point, is larger than the density values of density points at most a predetermined distance from said density point, by a predetermined value; and
when the distance in said attribute space, between a selected one of inspected data instance associated with a first respective unique identifier in a sorted list of unique identifiers and a respective K^{th} adjacent inspected data instance associated with a second respective unique identifier in the sorted list of unique identifiers, exceeds a distance threshold for K^{th} adjacency. The sorted list of unique identifiers define a sorted sequence of data instances. The respective K^{th} adjacent inspected data instance is K entries away from said selected inspected data instance in thesorted sequence of data instances.

### BRIEF DESCRIPTION OF THE DRAWINGS

The disclosed technique will be understood and appreciated more fully from the following detailed description taken in conjunction with the drawings in which:

FIG. 1, is a schematic illustration of an abnormal occurrence detection and management system constructed and operative in accordance with an embodiment of the disclosed technique;

FIGS. 2A, 2B, 2C and 2D are schematic illustrations of an exemplary two-dimensional attribute space in constructed and operative accordance with another embodiment of the disclosed technique;

FIG. 3 is an exemplary schematic illustration of a two-dimensional SEED metric, constructed and operative in accordance with a further embodiment of the disclosed technique;

FIG. 4 is a schematic illustration of a method for determining clusters of data measurements, for the purpose of classifying data, operative in accordance with another embodiment of the disclosed technique;

FIG. 5 is a schematic illustration of a method of classifying a real-time data point, operative in accordance with a further embodiment of the disclosed technique;

FIG. 6A is a schematic illustration of a normalized attribute space, constructed in accordance with another embodiment of the disclosed technique;

FIG. 6B is a schematic illustration of the normalized attribute space of FIG. 6A having two groups of data measurements;

FIG. 7 is a schematic illustration of a “pair distance versus time stamp” graph, plotting the distance between a real-time measurement and a selected preceding measurement versus the time stamp value of the real-time measurement, constructed in accordance with a further embodiment of the disclosed technique;

FIG. 8 is a schematic illustration of a “distance versus time difference” graph, representing the average distance between a selected pair of data measurements versus the time difference between the selected measurements, constructed in accordance with another embodiment of the disclosed technique;

FIG. 9 is a schematic illustration of a “probability versus distance” graph, representing the distribution of being at a selected distance from the location of a selected data measurement after a predetermined time period versus the selected distance, constructed in accordance with a further embodiment of the disclosed technique;

FIG. 10A is a schematic illustration of a “pair distance versus time stamp” graph, including a malfunctioning sensor occurrence, constructed in accordance with another embodiment of the disclosed technique;

FIG. 10B is a schematic illustration of a “pair distance versus time stamp” graph, including a water occurrence, constructed in accordance with a further embodiment of the disclosed technique;

FIG. 11 is a schematic illustration of a method for detecting and classifying occurrences in a supply system, operative in accordance with another embodiment of the disclosed technique; and

FIG. 12 is a schematic illustration of a method for detecting abnormal occurrences, operative in accordance with a further embodiment of the disclosed technique.

### DETAILED DESCRIPTION OF THE EMBODIMENTS

The disclosed technique overcomes the disadvantages of the prior art by providing a system and a method for detecting abnormal occurrence. According to the disclosed technique, at least one abnormal data instance is detected from a plurality of such data instances. Each data instance includes values associated with at least one physical attribute (e.g., temperature, height, time). These values define the location of each of the data instances in an attribute space. Some of the dimensions of the attribute space are each associated with a respective physical attribute.

The data instances are inspected to determine if a selected one of the data instances corresponds to an abnormal occurrence. A selected one of the data instances is defined as corresponding to an abnormal occurrence when a density point associated with that selected one of the inspected data instances is not associated with a hilltop point. The density point is defined as a location in the attribute space, associated with a value representing the number of analyzed data instances in a predefined area around that location. The hilltop point is defined at least when the density value of a density point, is larger than the density values of density points at most a predetermined distance from that density point, by a predetermined value.

Alternatively, a selected one of the inspected data instances is defined as corresponding to an abnormal occurrence when the distance in the attribute space, between that selected one of the inspected data instances and a respective K^{th} adjacent one of the inspected data instances, exceeds a distance threshold for K^{th} adjacency. The selected one of the inspected data instances is associated with a first respective unique identifier in a sorted list of unique identifiers, and the respective K^{th} adjacent one of the inspected data instances is associated with a second respective unique identifier in said sorted list of unique identifiers. The sorted list of unique identifiers defines a sorted sequence of data instances. The respective K^{th} adjacent one of the inspected data instances being K entries away from the selected one of the inspected data instances in the sorted sequence of data instances.

An abnormal occurrence may occur in a variety of applications. In each such application, the respective physical attributes are acquired or measured. For example, in a water supply system the physical attributes may be salinity, acidity (pondus Hydrogenii-pH), temperature, conductivity, Total Organic Carbon (TOC), residual chlorine, alkalinity, nitrate (NO₃), Oxidation Reduction Potential (ORP), turbidity, UV optical density at 254 nm (UV254), hardness, pressure, flow rate and the like. In an electrical supply system the physical attributes may be electric current, voltage, phase, frequency, location in the network and the like. In supply systems, the physical attributes are acquired by measurements from a sensor or a group of sensors. Furthermore, an abnormal occurrence may be detected in a population of humans. In human population the physical attributes are, for example, date of birth, place of birth, gender, height, weight, hair color, build, illnesses and the like. An abnormal occurrence may be detected in computer systems and networks. For example, a user may wish to detect abnormal e-mail traffic in an organization (e.g., a company, a government office and the like). When detecting abnormal e-mail traffic the acquired physical attributes may be the time and date of each e-mail was sent, the size in kilobytes of each e-mail, the IP and MAC addresses of the sender and recipients of each e-mail, if the e-mail included attachments and the like. Additional examples may include detecting abnormal occurrences in monitored air traffic, sea traffic and road traffic.

Herein below, the disclosed technique is explained using the supply system example. In the description herein below, an occurrence is also referred to as an ‘event’ and an abnormal occurrence is also referred to herein below as an ‘infrequent event’. Furthermore, the data instances in supply systems are produced by data measurements of the physical attributes of the supply systems. These data measurements may be real-time data measurements (i.e., the inspected data instances) or the pre-acquired data measurements (i.e., the analyzed data instances).

According to the disclosed technique, an event detection and management system includes a plurality of sensor units, which provide real-time data measurements to an event detector. The event detector classifies data measurements or sequences of data measurements as either a frequent event or an infrequent event (i.e., either normal or abnormal occurrences, respectively). The event detector can employ different data analysis methods, as detailed herein below, for identifying and for classifying events occurring in the supply system. Furthermore, the event detector may also employ heuristics to determine the nature of the event.

As mentioned above, the event detector can employ different data analysis methods for identifying and for classifying events of the supply system. In accordance with a first data analysis method of the disclosed technique, the event detection and management system employs a novel clustering method for detecting the events. The first data analysis method of the disclosed technique is also referred to herein below as a clustering data analysis method. According to the clustering data analysis method, prior to classifying real-time measurements, a plurality of sensor units, each including a plurality of sensors, measure data relating to the supply system (e.g., flow rate in a water supply system or current in an electrical supply system). These measurements are stored in a database as data entries. The event detector partitions these data entries into subsets. The event detector uses these partitions when classifying a real-time data measurement as a frequent event or as an infrequent event.

According to the first data analysis method of the disclosed technique, normalized measured data is projected onto an attribute space. As mentioned above each sensor, which measures a respective attributes corresponds to a dimension in the attribute space. Different sensors, measuring the same physical attributes, are associated with different respective dimensions of the attribute space.

A grid is determined for the attribute space, which partitions each dimension of the attribute space into a plurality of sections. The intersections of the grid lines define a plurality of grid points. For each grid point, a respective cell is determined. In addition, for each cell, a density value is determined according to the number of measurements in that cell, and a density point, associated with the density value, is defined within the cell. The location of the density point may be the location of the grid point associated with that cell or the average location of the data points within the cell.

From the density points, at least one hilltop point is determined (i.e., the density points exhibiting the largest density values as further explained below). After the hilltop points are determined, each of the remaining density points is associated with a respective hilltop point, according to the distance between the density point and the hilltop point and according to the density gradient between the density point and hilltop point. The distance metric used may be the ‘Square Equivalent Euclidean Distance’ as further explained below.

Each real-time measurement (i.e., inspected data instance) projected onto the attribute space is defined as a real time data point on the attribute space. Each real-time data point is associated with a density point. A real-time data point is classified as an infrequent event (i.e., abnormal occurrence) at least when the respective density point associated with the real-time data point is not associated with a hilltop point.

In accordance with a second data analysis method of the disclosed technique, the event detection and management system relates to the distance of a real time measurement from a respective selected adjacent measurement, for detecting the events. The second data analysis method of the disclosed technique is also referred to herein below as a relative distance data analysis method. Each of the data measurements includes a time stamp (i.e., a data field detailing the time at which the data measurement was acquired). This time stamp may be used as a unique identifier of the data measurement. Thus, the data measurements can be chronologically arranged.

The event detector determines the coordinates of each of the normalized data measurements in an attribute space (i.e., projects the data measurements onto the attribute space). It is noted that the time stamp is not an attribute of the supply system and accordingly the attribute space does not include a time dimension. Additionally, the event detector determines for each data measurement, at least the distance between the measurement and a respective selected adjacent (i.e., either preceding or succeeding) measurement. The distance can be measured in normalized Euclidian units or according to another distance metric, such as the SEED metric.

According to the second data analysis method of the disclosed technique, the distance between the data measurement and the respective selected adjacent data measurement corresponds to a random walk (RW) motion pattern. In the examples detailed herein below, the adjacent data measurement is a preceding data measurement, acquired prior to the selected data measurement. The distance between a data measurements T_{N} and a respective selected preceding data measurement T_{N-K} (i.e., the distance D(T_{N}−T_{N-K})) is considered as one step of the RW motion pattern. The distance D(T_{N+1}−T_{N-K+1}) is considered as a consecutive step of the RW motion pattern, and so forth.

In case a step of the RW motion pattern D(T_{N}−T_{N-K}) deviates from the RW motion pattern, the event detector identifies the data measurement T_{N} as an infrequent event. For example, a distance can be determined to be deviating from the RW motion pattern when exceeding a pre-determined step size threshold (i.e., distance threshold for K^{th} adjacency). The event detector pre-determines the step size threshold for the RW motion pattern according to previous data measurements and previously determined distances between pairs of data measurements. It is noted that the “step size” (i.e., the distance between the location of the measurement and the location of the adjacent measurement, in the attribute space) is not discrete and is not fixed, but corresponds to a distribution function as detailed herein below with reference to FIG. 9. That is, the distances between pairs of data measurements correspond to a distributional RW motion pattern.

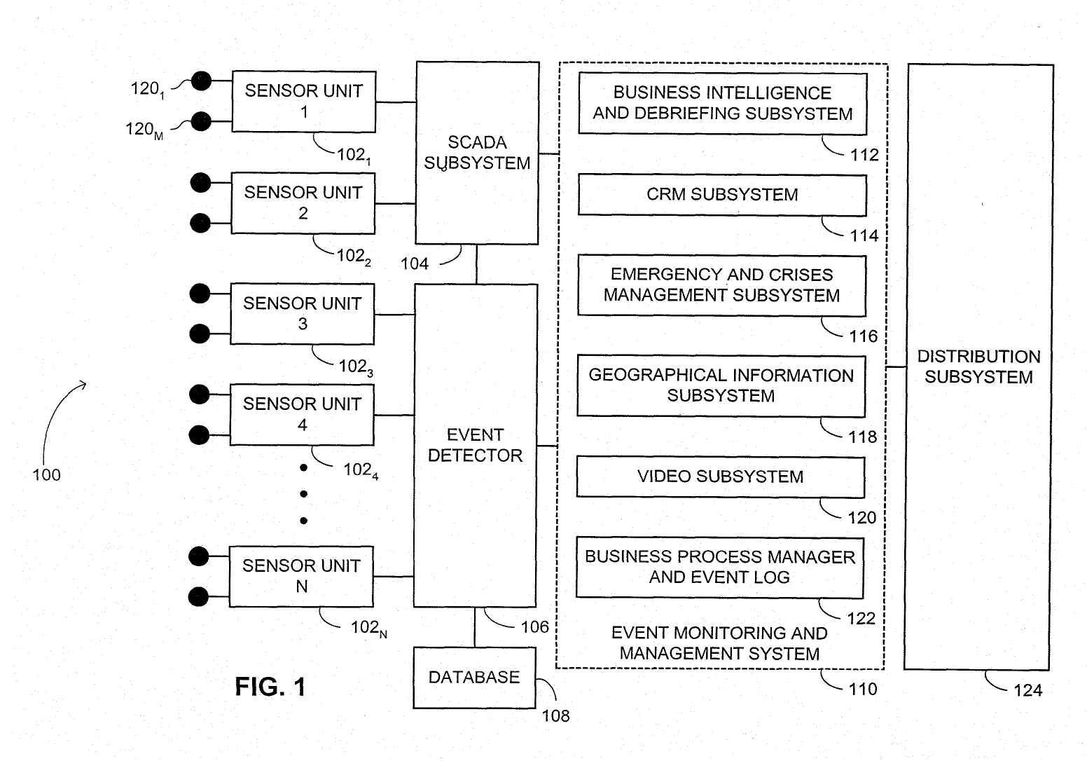

As mentioned above, the event detection methods of the disclosed technique may be incorporated in an event detection and management system. Reference is now made to FIG. 1, which is a schematic illustration of an event detection and management system, generally referenced 100, constructed and operative in accordance with an embodiment of the disclosed technique. System 100 includes a plurality of sensor units 102₁, 102₂, 102₃, 102₄ . . . 102_{N}, a Supervisory Control and Data Acquisition (SCADA) subsystem 104, an event detector 106, a database 108, an event monitoring and management system 110 and a distribution subsystem 124. Event monitoring and management system 110 includes a business intelligence and debriefing subsystem 112, a Customer Relationship Management (CRM) subsystem 114, an emergency and crises management subsystem 116, a geographical information subsystem 118, a video subsystem 120, a business process manager and event log 122. Each one of sensor units 102₁, 102₂, 102₃, 102₄ . . . 102_{N}, includes a plurality of respective sensors such as sensors 120₁ . . . 120_{M}.

In general, in an event detection and management system, such as event detection and management system 100, a portion of the sensor units are coupled directly to the event detector with the remaining ones of the sensor units being coupled with a SCADA subsystem. It is also noted that some of the sensor units may be coupled to both the SCADA subsystem and to the event detector. In FIG. 1, sensor units 102₁ and 102₂ are coupled with SCADA subsystem 104. The remaining ones of sensor units 102₃, 102₄ . . . 102_{N} are coupled with event detector 106. SCADA subsystem 104 is further coupled with event detector 106 and with event monitoring and management system 110. Event monitoring and management system 110 is further coupled with event detector 106 and with distribution subsystem 124. Event detector 106 is further coupled with database 108.

Each one of sensor units 102₁, 102₂, 102₃, 102₄ . . . 102_{N} acquires a plurality of real-time data measurements from the respective sensors thereof. Sensor units 102₁ and 102₂ provide the measured data to SCADA subsystem 104. Sensor units 102₃, 102₄ . . . 102_{N} provide the measured data to event detector 106. SCADA subsystem 104 monitors and controls the sites and infrastructure of a supply system (not shown) according to measurements acquired from sensor units 102₁ and 102₂. SCADA subsystem 104 provides the measurements acquired from sensor units 102₁ and 102₂, or a portion thereof, to event detector 106. Optionally, SCADA subsystem 104 may perform analysis of the measurements acquired from sensor units 102₁ and 102₂ and provides the results of this analysis to event detector 106, for example, as a vector of attributes as further explained below. For the remainder of this document, the term ‘measurement’ refers to a vector of attributes provided to event detector 106 either by sensor units 102₃, 102₄ . . . 102_{N} or by SCADA subsystem 104.

In accordance with the first data analysis method of the disclosed technique, also referred herein as ‘the clustering method’, and as further elaborated herein below with reference to FIGS. 1-5, prior to event detection, event detector 106 partitions data entries in database 108, corresponding to previous measurements, into subsets (i.e., event detector 106 determines clusters of data in database 108). Event detector 106 detects an event by classifying a real-time measurement as being either a normal event or an abnormal event by determining if that real-time measurement is associated with one of the above mentioned subsets. When a real-time data measurement is determined not to be associated with any one of the determined subsets, then that data measurement is classified an abnormal event. When a real-time data measurement is determined to be associated with any one of the determined subsets, then that data measurement is classified a normal event.

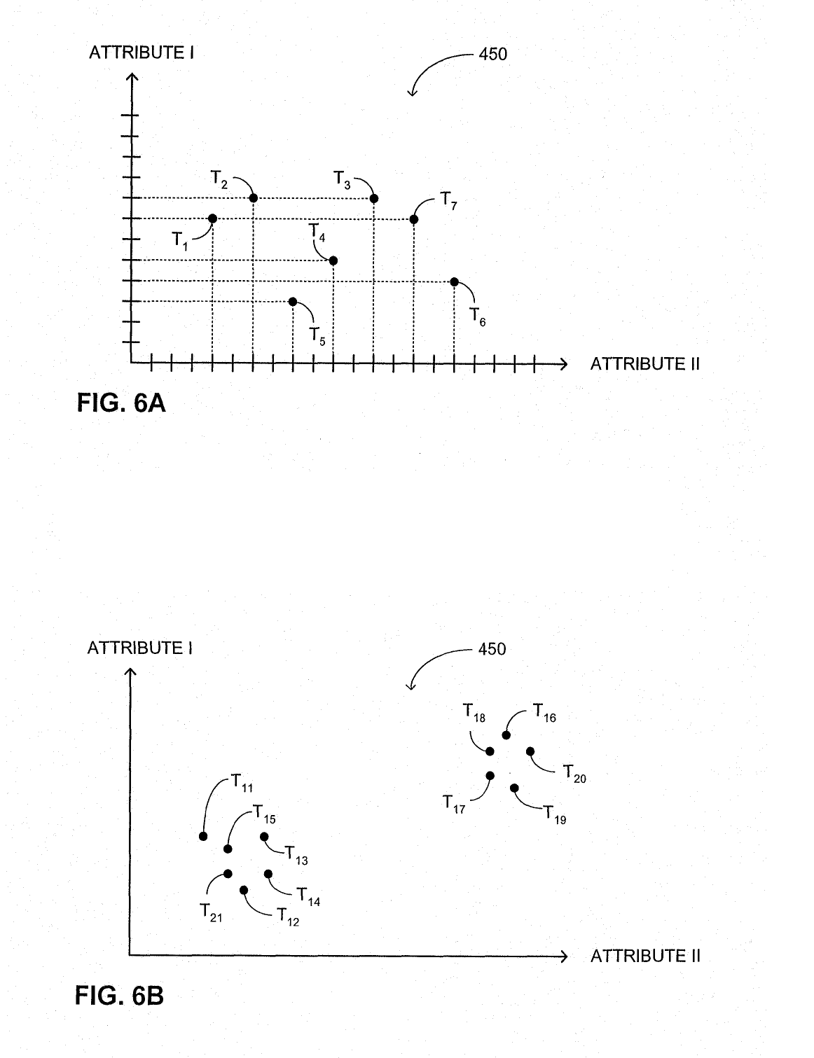

In accordance with the second data analysis method of the disclosed technique, also referred to herein as ‘the relative distance method’, and as further elaborated herein below with reference to FIGS. 6A-11, each of the data measurements is associated with a respective unique identifier, which defines a sortable sequence of data measurements. When detecting abnormal occurrences in humans, the identification number assigned to each individual when they are born may be used as the unique identifier. In the example set forth herein below the sortable unique identifier is a time stamp indicating the time at which the measurement was acquired. Alternatively, each data measurement includes a serial number or both a time stamp and a serial number, for enabling arrangement of the data measurements in a chronological order. For the rest of this application, as detailed herein below, a time stamp refers to a time data field, a serial number data field or both, of the respective data measurement.

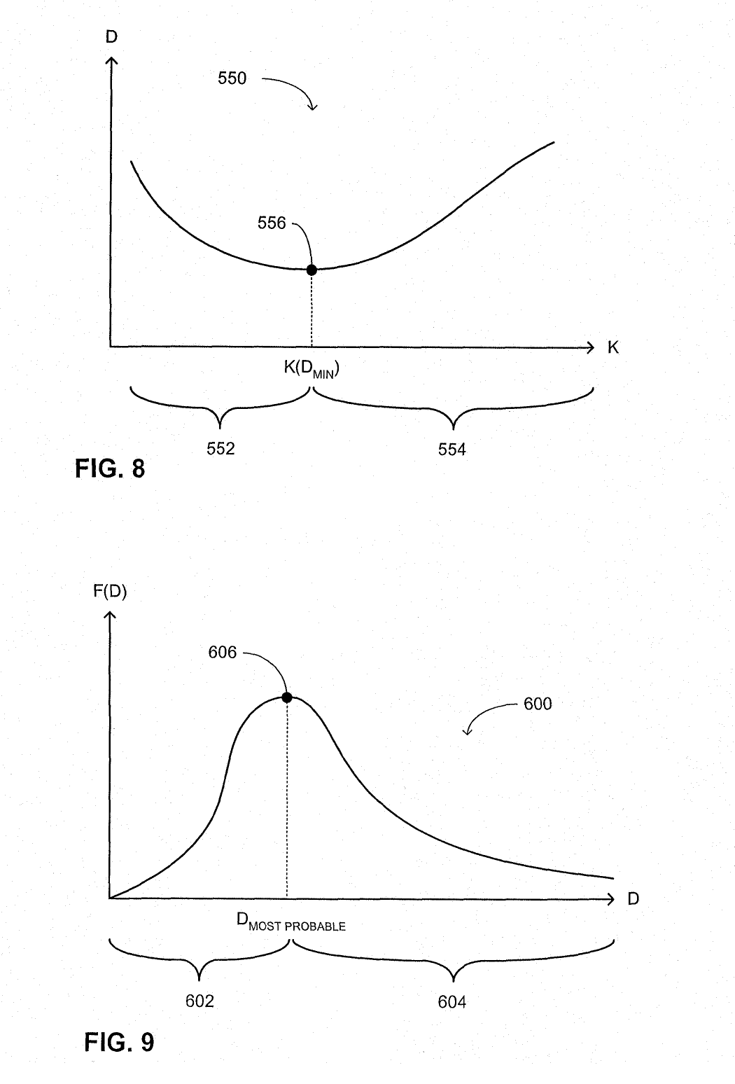

Further in accordance with the relative distance method of the disclosed technique, for at least one of the real-time data measurements, event detector 106 determines the distance between the real-time measurement and a selected preceding k^{th} measurement as detailed further herein below with reference to FIG. 6A. A preceding k^{th} measurement is a measurement acquired K time units, as determined by the sampling rate of the data measurements, before the current measurement. That is, K is the difference in the time stamp value (i.e., the time difference) between the real-time measurement and the selected adjacent k^{th} measurement. Alternatively, K represents the difference between the serial number of the data measurement and that of the preceding k^{th} measurement. Generally, K represents the difference in the values of the respective unique identifier between a data instance and a respective adjacent K^{th} data instance. The selected preceding k^{th} measurement is selected such that the distance between the data measurement and the selected K^{th} preceding measurement in the normalized attribute space is minimal, as detailed herein below with reference to FIG. 8.

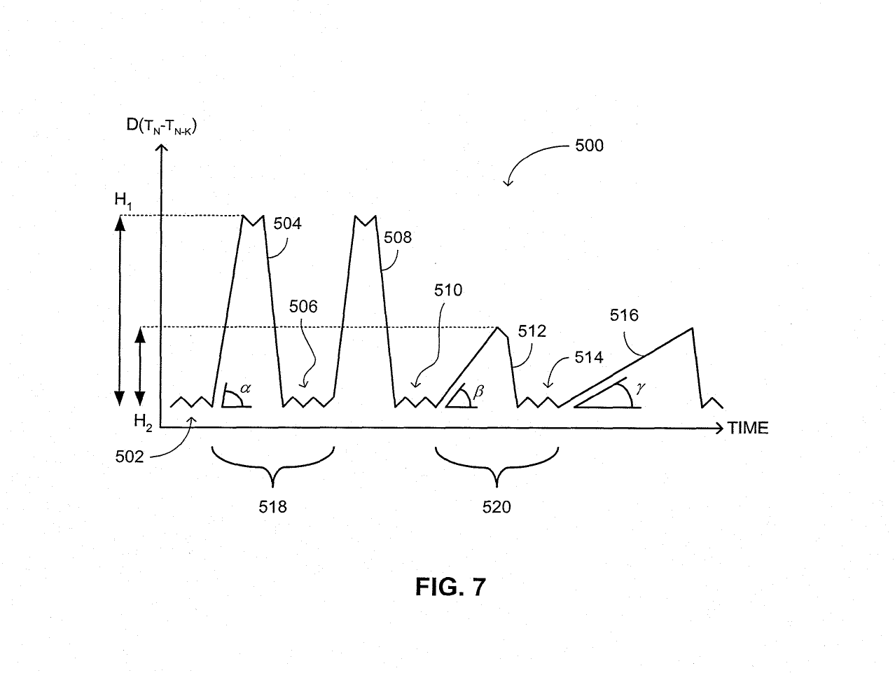

Thus, in accordance with the second data analysis method of the disclosed technique (i.e., the relative distance method), event detector 106 classifies a real-time data measurement, or a sequence of measurements, as an abnormal event according to the distance of the measurement from the preceding k^{th} measurement, as detailed further herein below with reference to FIG. 7. Specifically, event detector 106 determines the distance in the normalized attribute space between the location of the real-time data measurement and the location of the preceding K^{th} data measurement. In case the distance between the real-time measurement and the selected preceding k^{th} measurement does not correspond to a RW motion pattern (e.g., exceeds a step size threshold), the data measurement might be associated with an abnormal event.

When event detector 106 detects an event, event detector 106 provides information relating to the event (e.g., the classification of the event, the time and location of the event) to event monitoring and management system 110. In event monitoring and management system 110, business intelligence and debriefing subsystem 112 supports business decision making. To that end, business intelligence and debriefing subsystem 112 aggregates information from various subsystems such as geographical information subsystem 118, CRM subsystem 114, SCADA subsystem 104, an Enterprise Resource Planning (ERP) subsystem (not shown), spreadsheets, an access control subsystem (also not shown) which controls the access to the site of the supply system, video subsystem 120 and the like. Business intelligence and debriefing subsystem 112 performs analysis of the information provided by the various subsystems to determine, for example, business performance and benchmarking. This analysis includes analysis of historical data and real-time data as well as predictive analysis. Business intelligence and debriefing subsystem 112 also produces reports relating to the results of these analyses.

CRM subsystem 114 receives messages and tasks from customers. For example, in water supply systems, CRM subsystem 114 may receive a message indicating that the water at a certain location is murky or that the water at a certain location has a metallic taste. In electricity supply systems, CRM subsystem 114 may receive a message from customers indicating that the power at a certain location fluctuates. Such messages may relate to an unfolding event (i.e., an event which was previously detected and to which a response has been initiated) or may trigger a new event. CRM subsystem 114 dynamically links unfolding events with received real-time messages and determines if the real-time messages relate to the unfolding events or to new events. CRM subsystem 114 filters and prioritizes the received customer messages to prevent unnecessary allocation of resources (e.g., manpower, equipment and the like). Furthermore, CRM subsystem 114 analyzes the received messages and recommends a course of action.

Emergency and crises management subsystem 116 allows a user to control and monitor the operation of emergency resources. Such emergency resources are, for example, in a water supply system, emergency water reservoirs and distribution points. Emergency and crises management subsystem 116 further facilitates the recruitment of and the debriefing of emergency personal.

Geographical information subsystem 118 receives information relating to the geographical location of mobile personal and equipment (e.g., vehicles, sensor units) using tracking systems such as a Global Position System (GPS) or a Radio Frequency Identification (RFID). Geographical information subsystem 118 provides this information to the user and further relates events to the geographical location thereof.

Video subsystem 120 displays visual information of sites and events. Furthermore, video subsystem 120 allows a user to view specific cameras at selected sites and locations. For example, the user may select to view a camera located at the entrance to a site where an event was detected as well as to define a set of cameras to be automatically viewed when an event is detected.

Business process manager and event log 122 receives information relating to events from event detector 106, business intelligence and debriefing subsystem 112, CRM 114 and video subsystem 120 and manages these events. Managing events includes monitoring tasks, monitoring and controlling devices such as sensors, cameras and the like. Business process manager and event log 122 may further define user access privileges and rules, and control how data relating to an event is viewed and managed.

Distribution subsystem 124 receives information from event monitoring and management system 110 and distributes this information to relevant parties. For example, distribution subsystem 124 sends text messages (e.g., SMS) to selected personal when an event is detected. As a further example, distribution subsystem 124 sends e-mail messages to selected organizations including information relating to the detected event.

As mentioned above, prior to classifying real-time measurements, sensor units 102₁, 102₂, 102₃, 102₄ . . . 102_{N}, measure data relating to the supply system. These data measurements are stored in database 108 as data entries. Each data measurement may include the measurement of a plurality of attributes. For example, in water reservoir supervision systems, each measurement may include attributes such as salinity, acidity (pondus Hydrogenii—pH), temperature, conductivity, Total Organic Carbon (TOC), residual chlorine, alkalinity; nitrate (NO₃); Oxidation Reduction Potential (ORP); turbidity; UV optical density at 254 nm (UV254); hardness, pressure, flow rate and the like.

According to the disclosed technique, a measurement may be expressed in vector form as follows:

X=[x₁,x₂, . . . ,xₘ] (1)

where X represents a data measurement and x₁, x₂, . . . , xₘ represent the different attributes of the measurement. Alternatively, in case a data measurement is associated with a time stamp, the data measurement may be expressed in vector form as follows:

X=[x₁,x₂,x₃ . . . ,xₘ,t] (1)

where X represents a data measurement, x₁, x₂, . . . , xₘ represent the different attributes of the measurement and t represents the time stamp of the data measurement.

Since each attribute may be measured on a different scale (e.g., temperature is measured in degrees while salinity may be measured in milligrams per liter), according to the disclosed technique, the attributes of the data measurements are optionally normalized (i.e., brought to a common scale). Normalizing the attributes may be executed, for example, by subtracting from each attribute value the respective attribute average (i.e., the average of all the values of all the measurements of the same attribute), and dividing this difference by the standard deviation of the attribute values. This can be expressed mathematically as follows:

$${y}_{i} = \frac{{x}_{i} - {μ}_{i}}{{σ}_{i}} \qquad ( 2 )$$

where xᵢ is the measured attribute, μᵢ is the average value of the i^{th} attribute, σᵢ is the standard deviation of the attribute values and yᵢ is the normalized attribute value. Alternatively, normalizing may be achieved by dividing the difference between the value of the attribute and the lowest attribute value by the difference between the highest attribute values and the lowest attribute value. This may be expressed mathematically as follows:

$${y}_{i} = \frac{{x}_{i} - {x}_{min}}{{x}_{max} - {x}_{min}} \qquad ( 3 )$$

where xᵢ is the attribute value, xₘₐₓ is the highest attribute value, xₘᵢₙ is the lowest attribute value and yᵢ is the normalized attribute value. Employing the normalization expression described in Equation (3) may require outlier filtering (i.e., removing “spikes” in the data measurements), for example by using a median filter. Thus, the minimum and maximum values are maintained within a nominal range.

The normalized data measurements are projected onto an attribute space (i.e., either normalized or not normalized attribute space). The attribute space includes a plurality of dimensions, at most equal to the number of attributes in each data measurement. Each attribute is associated with a respective dimension. Each dimension is represented by a respective axis, orthogonal to all the other axes. When the data measurement includes a single attribute, the measurement space is a one-dimensional (1D) space. When the data measurement includes two attributes, the measurement space is a two-dimensional (2D) space. When the data measurement includes three attributes, the measurement space is a three-dimensional (3D) space and when the data measurement includes N attributes, the measurement space is an N-dimensional (ND) space. In the remainder of this document, a 2D measurement space is used as an example for describing the disclosed technique. It is noted that the time stamp associated with a data measurement is not an attribute of the data measurement (e.g., the attribute space does not include a time dimension and the time stamp is not normalized).

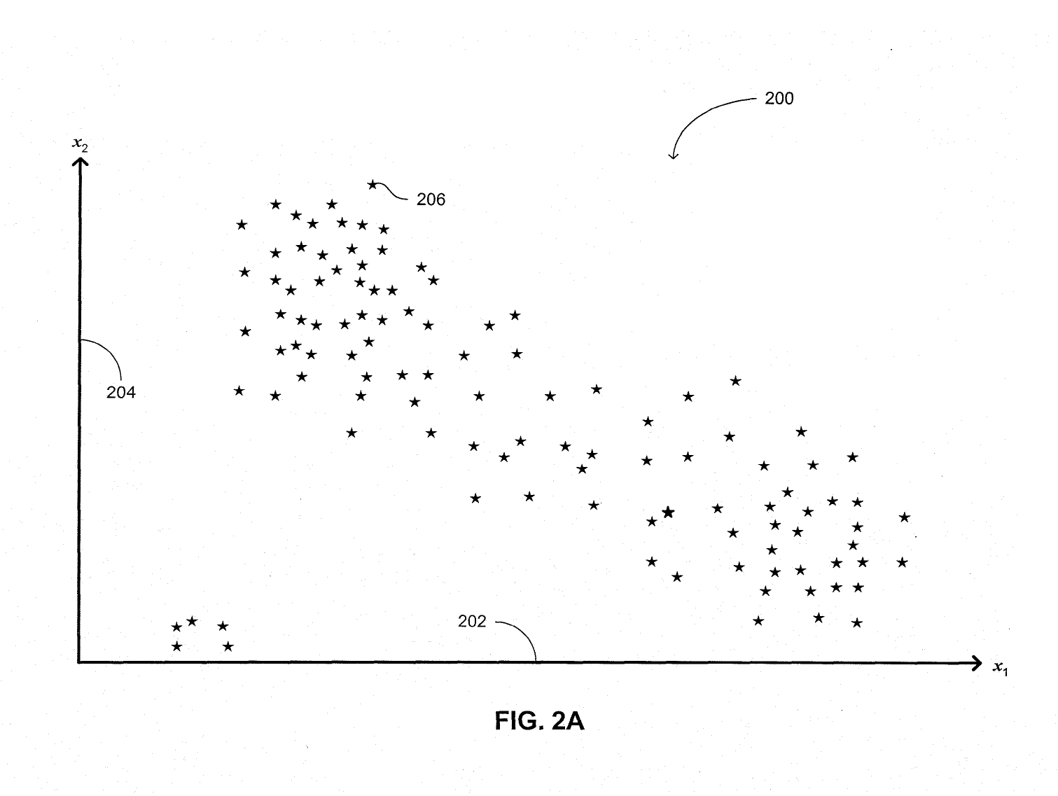

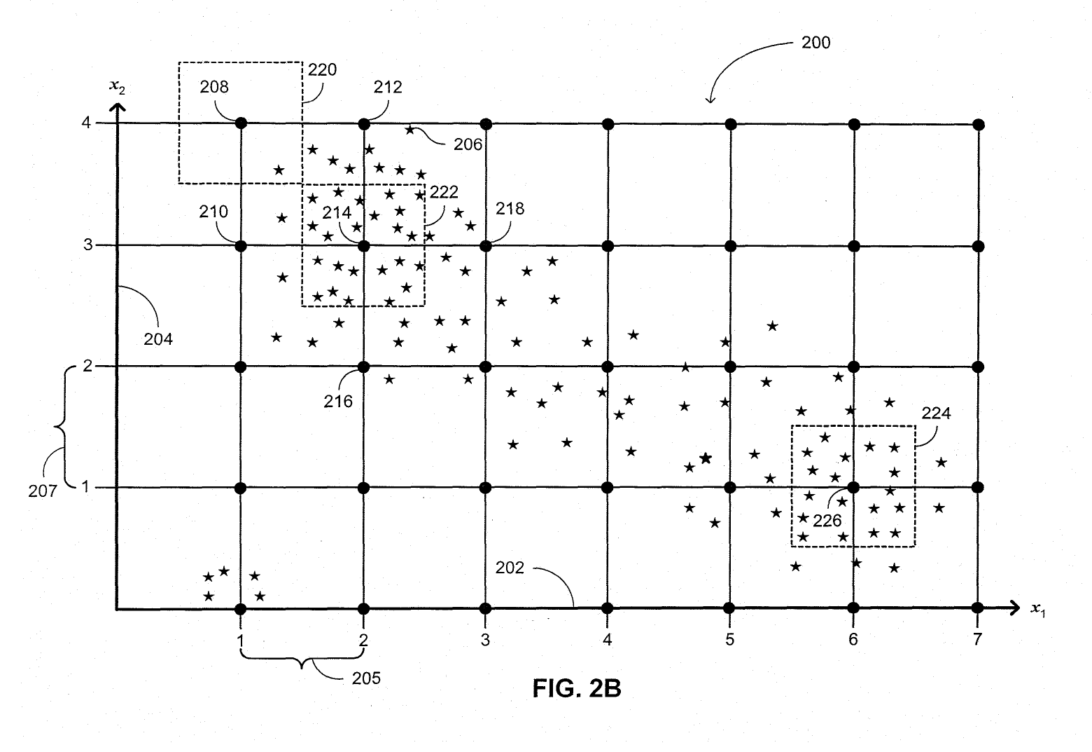

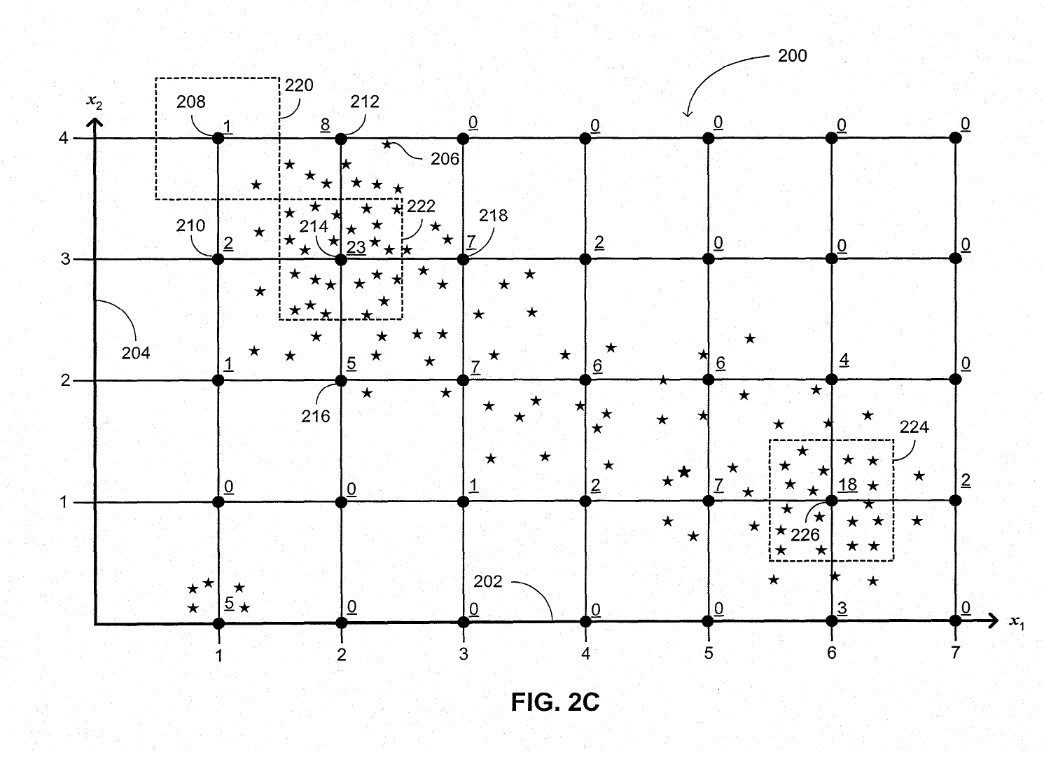

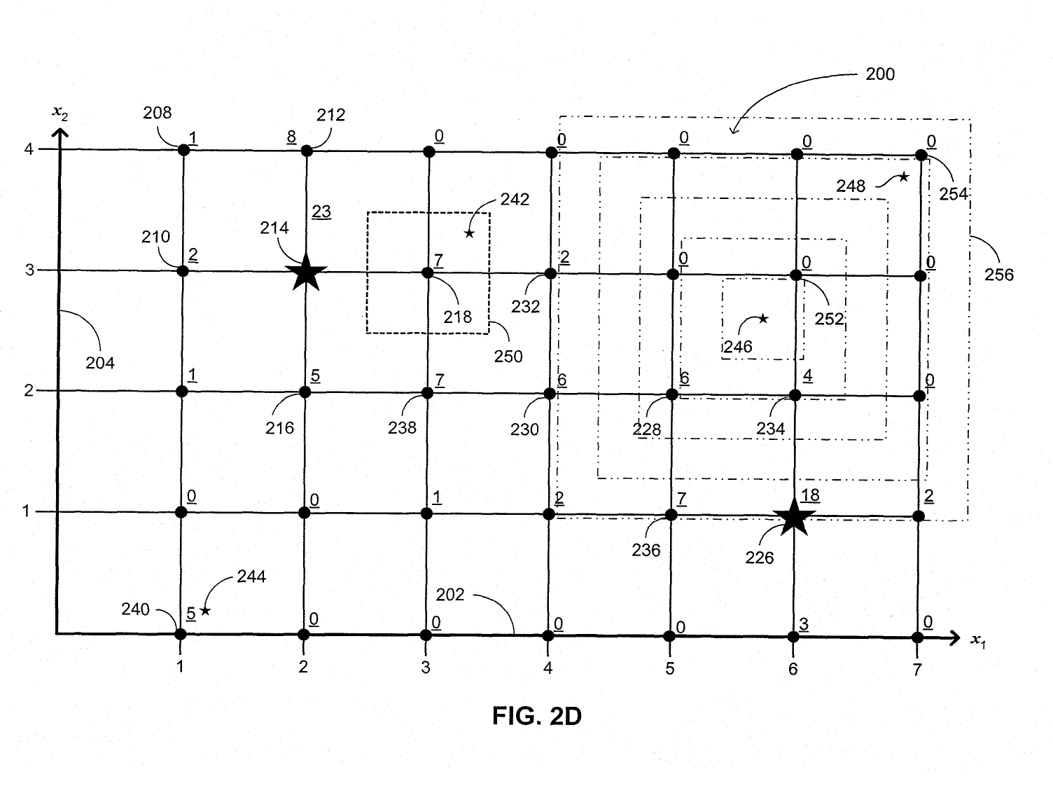

As mentioned above, the event detector (e.g., event detector 106 of FIG. 1) detects an event by classifying a real-time measurement as being either a normal event or an abnormal event by attempting to associate the real-time measurement with one of determined clusters of data points. The following description in conjunction with FIGS. 2A, 2B, 2C, 2D, 3, 4 and 5, relates to the first data analysis method of the disclosed technique (i.e., the clustering method). Reference is now made to FIGS. 2A, 2B, 2C and 2D, which are schematic illustrations of an exemplary two-dimensional attribute space, generally referenced 200, constructed and operative in accordance with another embodiment of the disclosed technique. Attribute space 200 includes two axes 202 and 204, respectively for each one of attributes x₁ and x₂. In attribute space 200, axis 202 is associated with attribute x₁ and axis 204 is associated with attribute x₂. Normalized data measurements are projected onto attribute space 200 according to the normalized values of the attributes. Thus, each normalized data measurement defines a data point, such as a point 206 in attribute space 200.

Additionally, according to the disclosed technique, a grid is determined for attribute space 200. Referring now to FIG. 2B, a grid partitions each dimension of attribute space 200 into a plurality of sections such as sections 205 and 207. The intersections of the grid lines in attribute space 200 define a plurality of grid points such as grid points 208, 210, 212, 214, 216, 218 and 226. A respective cell is then determined around each grid point, with each grid point representing the ‘cell center’ of the respective cell. According to the disclosed technique, the cells of respective adjacent grid points do not overlap. It is noted that the cell boundaries are not necessarily equally distant from the cell center and the grid points adjacent to the cell center (i.e., the cell boundaries are offset from the cell center). However, in general all cells should exhibit the same offset from the cell center. As shown in FIG. 2B, cell 220 is the cell respective of grid point 208 with grid point 208 being the cell center. Cell 222 is the cell respective of grid point 214 with grid point 214 being the cell center. Cell 224 is the cell respective of grid point 226 with grid point 226 being the cell center. In FIG. 2B, the boundaries of the cells are equally distant from the cell centers and the grid points adjacent to the cell centers. For example, the boundaries of cell 222 are equally distant from its cell center (i.e., grid point 214) and grid points 210, 212, 216 and 218, adjacent to the cell center. This however is merely an example, and the boundaries of cell 222 may not be equally distant from its cell center. According to one embodiment of the disclosed technique, the spacing between the grid lines, in each dimension in the attribute space, is determined according to the normalized standard deviation of the attributes respective of that dimension or to a function of the standard deviation, for example the logarithm of the standard deviation or any transformation of the original data. It is noted that different respective spacing may be determined for each axis.

For each cell, a density value is determined. The density value is determined according to the number of measurements in the cell associated with each grid point. A grid point with a corresponding density value defines a density point. In general, a density point is a location in a cell associated with a value related to the number of measurements in the cell. The location of the density point may be the grid point associated with the cell or the average location of the data points within the cell. Referring now to FIG. 2C, a density value is shown associated with each grid point. Density values are shown in FIG. 2C as underlined numbers adjacent to respective grid points. The density values are the number of measurement points within the respective cells of the grid points. For example, the density value associated with grid point 208 is 1 (i.e., determined by counting the number of measurement points within cell 220). The density value associated with grid point 210 is 2. The density value associated with grid point 212 is 8. The density value associated with grid point 214 is 23. The density value associated with grid point 216 is 5. The density value associated with grid point 218 is 7 and the density value associated with grid point 226 is 18. As mentioned above, a grid point with its associated density value is herein referred to as a ‘density point’. In essence, the density points define a density function of the data points.

After the density points are determined, ‘hilltop’ points are determined from the density points. These hilltop points represent local maximums of the density function. A density point is defined as a hilltop point when the following conditions occur:
There are a minimum number of grid points around the density point;
The density value of the density point is larger by a predetermined value than the density values of other density points at most a predetermined distance from the density point.

Optionally, hilltop points are also located at least a predetermined distance from any other hilltop point in attribute space 200. It is noted that the above mentioned number of grid points, predetermined values and predetermined distances are configurable parameters determined, for example, by a user. With reference to FIG. 2C, grid points 214 and 226 are determined as hilltop points in attribute space 200, since, for example, there are more than 5 other grid points around grid points 214 and 226. Furthermore, the density values of each of grid points 214 and 226 are larger by at least 10 from any other density points at least a predetermined distance therefrom.

After the hilltop points are determined, each of the remaining density points is associated with a respective hilltop point. For each density point, the closest hilltop point is selected, and the density gradient between the density point and the hilltop point is determined. The density gradient may be estimated by determining the average density in either a quadrilateral or a line defined by the density point and the closest hilltop point. When this average density is higher than the value of the density point, then the gradient is determined as increasing and the density point is associated with the selected hilltop point. When this average density is lower than the value of the density point, then the gradient is determined as decreasing and the next closest hilltop is searched for.

Referring now to FIG. 2D an example of hilltop association and density gradient determination is shown. A density point 218 is associated with hilltop point 214, since hilltop point 214 is the closest hilltop to density point 218 and the density gradient, defined by the average density of the density points in the quadrilateral defined by density point 218 and hilltop point 214 (i.e., the quadrilateral is defined by grid points 214, 216, 218 and 220) is higher than the density value of density point 218. The average density of the density points in the quadrilateral defined by density point 218 and hilltop point 214 is 10.5 and the density value of density point 218 is 7. As another example, density point 230 is equally distant from hilltop points 214 and 226. However, the average density of the density points in the quadrilateral defined by density point 230 and hilltop point 214 is 8.11, whereas the average density of the density points in the quadrilateral defined by density point 230 and hilltop point 226 is 7.16. Consequently, density point 230 is associated with hilltop point 214. It is noted that not all the density points in a grid must be associated with a hilltop. For example, when a density point is more than a predetermined distance away from the closest hilltop point, that density point may not be associated with any hilltop point. This predetermined distance away from the closest hilltop point is also a configurable parameter. For example, in FIG. 2D, density point 240 is not associated with either one of hilltop points 214 or 226. However, according to the disclosed technique, a hilltop point, with its associated density points determines a cluster of data points.

When a real-time data measurement is acquired, the data measurement should be classified as either a normal event or an abnormal event. To that end, when a real-time data measurement is received, that data measurement is projected onto the attribute space as a real time data point. Thereafter, the real-time data point is associated with a respective density point. The cell in which this real-time data point is located is determined according to the coordinates of the real-time data point. Consequently, the density point associated with that cell is also determined (i.e., the density point associated with the cell in which the real-time data measurement is located). This density point, is the density point associated with the real-time data point. The real-time data point shall be classified a normal event, when one of the following conditions occurs:
The respective density of the density point associated with the real-time data point is associated with a hilltop point, and thus with a cluster, therefore, the new real-time data point is also associated with that cluster.
The density value of the density point associated with the real-time data point is above a predetermined density threshold value.
The real-time data point is at most a predetermined distance threshold value from a hilltop point.
   The above mentioned density threshold value and distance threshold value may be configurable parameters.

Referring to FIG. 2D, data point 242, 244, 246 and 248 are real-time data points. Data point 242 is located within cell 250, which is associated with density point 218. Thus, density point 218 is associated with data point 242. Similarly, density points 240, 252 and 254 are the respective density points of data points 244, 246 and 248 respectively.

Density point 218 is associated with hilltop point 214. Thus, data point 242 is regarded as being a part of the cluster associated with hilltop point 214. Consequently, data point 242 is classified a normal event. Density point 240 is not associated with any one of hilltop points 214 and 226. However, the density value of density point 240 is above a predetermined density threshold (e.g., 4). Thus, data point 244 is also classified a normal event. Density point 252 is not associated with any one of hilltop points 214 and 226 and the density value thereof is below the predetermined density threshold. However, data point 246 is within a predetermined distance from the nearest hilltop point (i.e., hilltop point 226). Thus, data point 246 is also classified a normal event. Density point 254 is not associated with any one of hilltop points 214 and 226 and the density value thereof is below the predetermined density threshold. Furthermore, data point 248 is not within the predetermined distance from the nearest hilltop point. Thus, data point 248 is classified an abnormal event. It is noted that the real-time data points may optionally be used to update the density values of the respective density points thereof, thus updating the density function.

As mentioned above, the distance between each density point and a hilltop point, as well as the distance between a real-time data point to the closest density point, is determined. The distance measure between these points in the attribute space may be, for example, the Euclidian distance. However, determining the Euclidian distance between two points in the attribute space may be computationally expensive, since such a computation involves determining the square root of the sum of the squared differences between the coordinates of the two points. Moreover, the computational cost increases when a plurality of such computations is required. Thus, the Euclidian distance may not be scalable for databases storing large sets of data entries (e.g., on the order of millions of entries or more). According to the disclosed technique, a novel distance metric is used to determine the distance between two points in the attribute space. This novel distance metric is referred to herein as the ‘Square Equivalent Euclidian Distance’ (SEED).

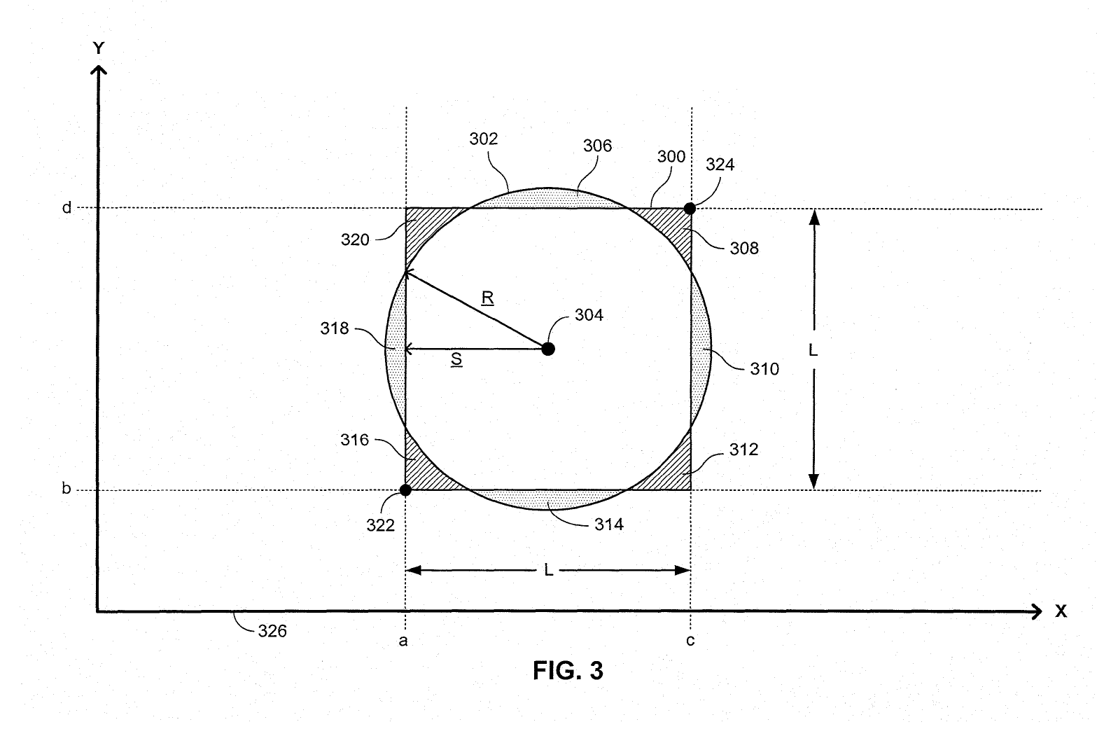

Reference is now made to FIG. 3, which is an exemplary schematic illustration of a two-dimensional SEED metric, constructed and operative in accordance with a further embodiment of the disclosed technique. According to the SEED metric, a square 300 and a circle 302 are centered about a common point 304. Circle 302 exhibits a radius R. Square 300 exhibits a side of length L. SEED is defined as half of L. The dimensions of square 300 (i.e., L) are determined such that the total area of hatched portions 308, 312, 316 and 320 is equal to the total area of dotted portions 306, 310, 314 and 318. The dimensions of square 300 are determined by equating the area of square 300 with the area of circle 302. Accordingly, after solving the equated areas, SEED (i.e., half the length of the side of square 300) is determined according to the following equation:

$$SEED = \frac{\sqrt{π} R}{2} \qquad ( 4 )$$

All points lying on the rim of square 300 are estimated as being at a distance R from common point 304. For example, when all points within a distance of at most R from common point 304 are to be determined, S is determined according to Equation (4) and all points lying within square 300, defined by S and common point 304, are considered to be a distance R or less from common point 304.

It is noted that the SEED depicted in FIG. 3 and Equation (4) apply to the 2D case. In the 3D case, the SEED is determined by equating the volume of a sphere to the volume of a cube. In the ND case, the SEED is determined by equating the volume of a hypersphere to the volume of a hypercube. When the number of dimensions is even, the SEED is determined as follows:

$$SEED = \frac{R}{2} * \sqrt[n]{\frac{2 {π}^{n / 2}}{2 * 4 * … n}} \qquad ( 5 )$$

When the number of dimensions is odd, the SEED is determined as follows:

$$SEED = \frac{R}{2} * \sqrt[n]{\frac{2 * 2 {π}^{( n - 1 ) / 2}}{1 * 3 * … n}} \qquad ( 6 )$$

In Equations (5) and (6) n represents the number of dimensions. It is noted that the number of dimensions n equals the number of dimensions of the attribute space.

Referring back to FIG. 2D, for example, the distance between data point 246 and the closest hilltop point thereto is determined according to the Square Equivalent Euclidian Distance, i.e., the SEED. Initially a square, with initial dimensions, is determined (e.g., a predetermined fraction of the grid spacing). When this initial square does not already include a hilltop point, the dimensions of the square are iteratively increased until a hilltop point (i.e., the coordinates of the hilltop point) either lies on the rim of the square or is within the square. That hilltop point is determined as the closest hilltop point to data point 246. As mentioned above, in FIG. 2D, the hilltop point determined to be the closest to data point 246 is hilltop point 226. The iterative increase of the dimensions of the square is represented by the dashed double-dotted squares in FIG. 2D. Square 256 was the first square to include hilltop point 226. According to the SEED, hilltop point 226 is considered to be a distance R from data point 246 according the dimensions of square 256 and Equation (4). Similarly, the distance between any other two points in attribute space 200 may be determined.

Whether a point (e.g., a data point, a density point or a hilltop point) lies on the rim of the square or inside the square may be determined by comparing the coordinates of the point with the coordinates of two diagonally opposing points of the square. Referring back to FIG. 3, square 300 may be defined by points 322 and 324 in a coordinate system 326. Points 322 and 324 are diagonally opposing points of square 300. Point 322 has coordinates [a,b] in coordinate system 326 and point 324 has coordinates [c,d] in coordinate system 326. A point is defined as lying on or within square 300 by comparing the coordinates [x,y] of that point with the coordinates of points 322 and 324. When both of the following conditions occur:

c≧x≧a (7)

d≧y≧b (8)

the point [x,y] is determined as lying on or within square 300. Equations (7) and (8) are the conditions for a point to be on or within a square in the 2D case. In the ND case, the point should be on the rim of a hypercube or within a hypercube. It is noted that the SEED is a trade off between accuracy and complexity of distance measurement.

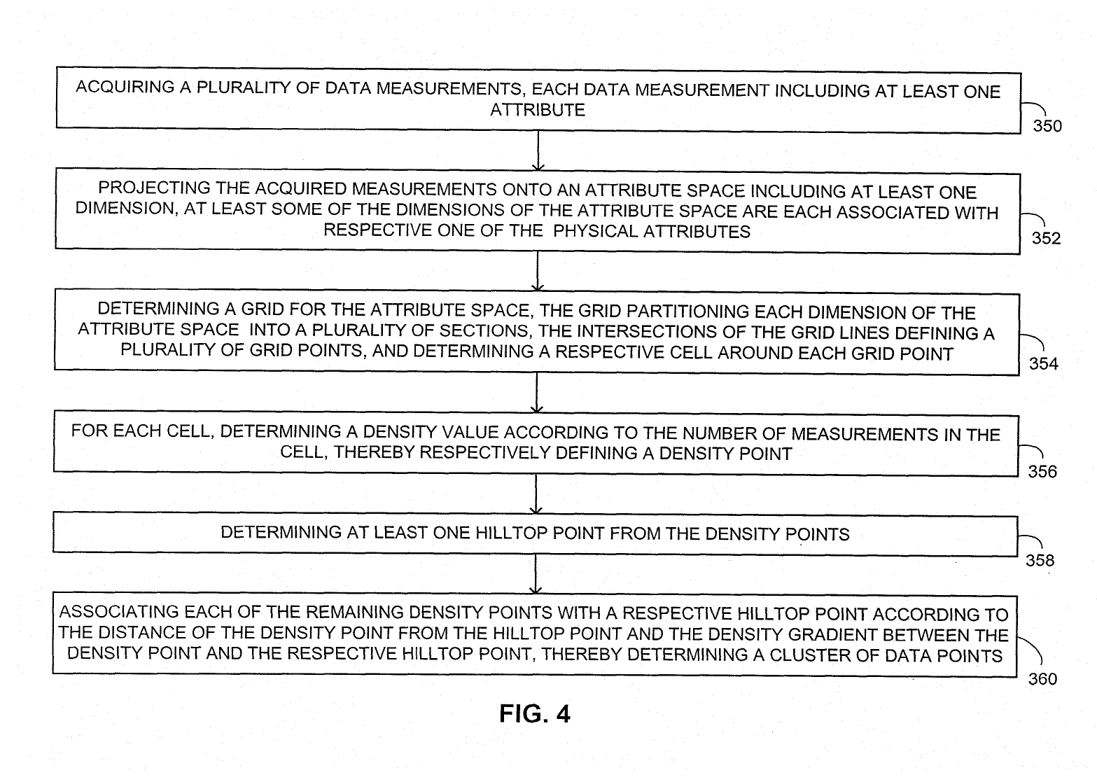

Reference is now made to FIG. 4, which is a schematic illustration of a method for determining clusters of data measurements, for the purpose of classifying data, operative in accordance with another embodiment of the disclosed technique. In a procedure 350, a plurality of data measurements is acquired, each data measurement including at least one attribute. Since each attribute may be measured on a different scale, the attributes of the data measurements are optionally normalized.

In a procedure 352, the acquired measurements are projected onto an attribute space as data points. The attribute space includes at least one dimension. At least some of the dimensions of the attribute space are each associated with respective one of the physical attributes. In a supply system, each sensor is associated with a respective dimension in the attribute space. Different sensors, measuring the same physical attributes, are associated with different respective dimensions. With reference to FIG. 2A, normalized data measurements are projected onto attribute space 200 as data points.

In a procedure 354, a grid is determined for the attribute space. The grid partitions each dimension of the attribute space into a plurality of sections. The intersections of the grid lines define a plurality of grid points. Furthermore, a respective cell is determined around each grid point. With Reference to FIG. 2B, a grid partitions each dimension of attribute space 200 into a plurality of sections. The intersections of the grid lines define a plurality of grid points such as grid points 208, 210, 212, 214, 216, 218 and 226. A cell 222 is determined, for example, around grid point 214.

In procedure 356, a density value is determined for cell according to the number of measurements in the cell, thereby respectively defining a density point. Referring to FIG. 2C, for example, the density value associated with grid point 214 is 23.

In a procedure 358, hilltop points are determined from the density points. A hilltop point is defined as a density point when the following conditions occur:
There are a minimum number of grid points around the density point;
The density value of the density point is larger than the density values of density points at most a predetermined distance from the density point, by a predetermined value.

Optionally, hilltop points are also located at least a predetermined distance from any other hilltop point in attribute space. With reference to FIG. 2D, density points 214 and 226 are determined as hilltop points.

In a procedure 360, each of the remaining density points in the attribute space is associated with a respective hilltop point according to the distance of the density point from the hilltop point and the density gradient between the density point and the respective hilltop point, thereby determining a cluster of data points. For each density point, the closest hilltop point is determined as well as the density gradient between the density point and the hilltop point. The density gradient may be estimated by determining the average density in the quadrilateral defined by the density point and the hilltop point. When this average is higher than the value of the density point, then the gradient is determined as increasing and the density point is associated with the hilltop point. When this average is lower than the value of the density point, then the gradient is determined as decreasing and the next closest hilltop point is searched for. With reference to FIG. 2D, density point 218 is associated with hilltop point 214, since hilltop point 214 is the closest hilltop point to density point 218 and the average density of the density points in the quadrilateral defined by density point 218 and hilltop point 214 is higher the density value of density point 218.

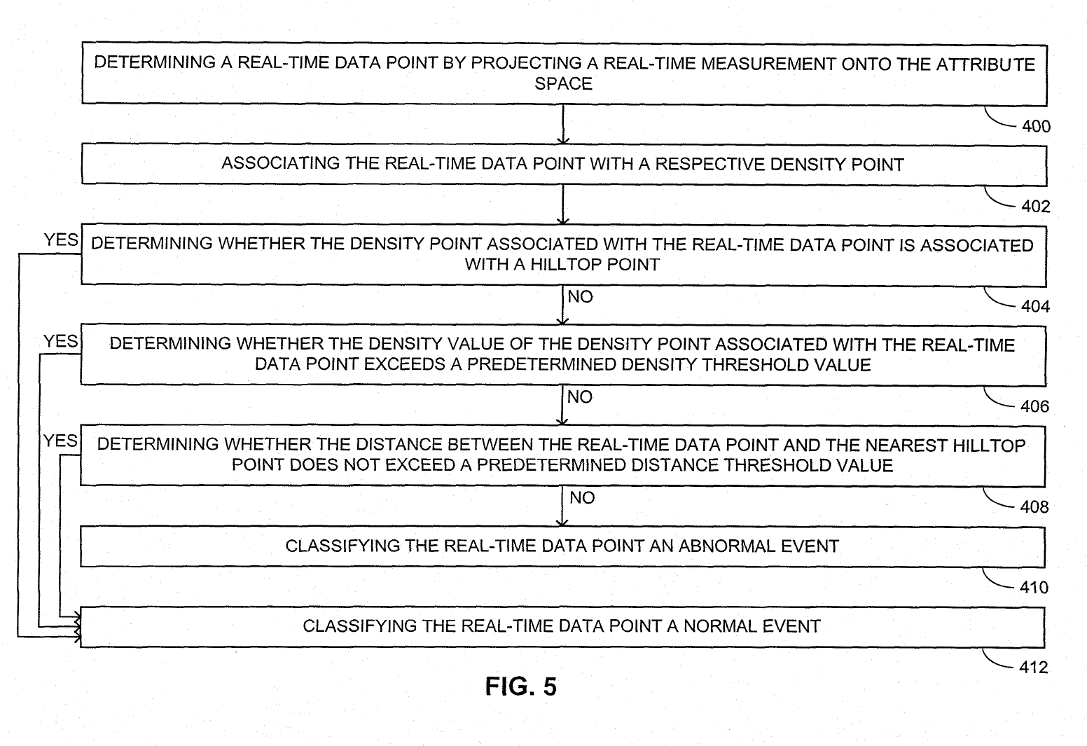

Reference is now made to FIG. 5, which is a schematic illustration of a method of detecting abnormal events in a supply system, operative in accordance with a further embodiment of the disclosed technique. In procedure 400, a real-time data point is determined by projecting a real-time measurement onto an attribute space. With reference to FIG. 2D, real-time data points 242, 244, 246 and 248 are determined. With reference to FIG. 1, event detector 106 determines a real-time data point by projecting a real-time measurement onto the attribute space.

In procedure 402, the real-time data point is associated with a respective density point. The cell in which this real-time data point is located is determined according to coordinates of the real-time data point. Consequently, the density point associated with that cell is also determined. This density point is the density point associated with the real-time data point. With reference to FIG. 2D, density points 218, 240, 252 and 254 are determined as the density points associated with real-time data points 242, 244, 246 and 248 respectively. With reference to FIG. 1, event detector 106 determines the density point associated with the real-time data point.

In procedure 404, it is determined whether the density point associated with the real-time data point is associated with a hilltop point. When the density point associated with the real-time data point is determined to be associated with a hilltop point and thus with a cluster, the method proceeds to procedure 412. When the density point associated with the real-time data point is determined not to be associated with a hilltop point, the method proceeds to procedure 406. With reference to FIG. 2D, density point 218, with respect to data point 242 is determined to be associated with hilltop point 214. Density points 240, 252 and 254, associated respectively with data points 244, 246 and 248 are determined not to be associated with either one of hilltop points 214 and 226. With reference to FIG. 1, event detector 106 determines whether the density point associated with the real-time data point is associated with a hilltop point.

In procedure 406, it is determined whether the density value of the density point associated with the real-time data point is above a predetermined density threshold value or not. When the density value of the density point associated with the real-time data point is determined to be above the density threshold value, the method proceeds to procedure 412. When the density value of the density point associated with the real-time data point is determined to be below the density threshold value, the method proceeds to procedure 408. With Reference to FIG. 2D, for example, the density value of density point 240, associated with data point 244, is above a predetermined density threshold value. However, the density values of density points 252 and 254, respectively associated with data points 246 and 248, are below the density threshold value. With reference to FIG. 1, event detector 106 determines whether the density value of the density point associated with the real-time data point is above a predetermined density threshold value.

In procedure 408, it is determined whether the distance between the real-time data point and the nearest hilltop point exceeds a predetermined distance threshold value or not. When the distance does not exceed the distance threshold value, the method proceeds to procedure 412. When the distance is above the distance threshold value, the method proceeds to procedure 410. The distance between the real-time data point and the closest hilltop point may be determined according to the Square Equivalent Euclidean Distance of the disclosed technique as described above. With Reference to FIG. 2D, for example, the distance between data point 246 and hilltop point 226 is below the distance threshold value while the distance between data point 248 and hilltop point 226 is above the distance threshold value. With reference to FIG. 1, event detector 106 determines whether the distance between the real-time data point and the nearest hilltop point thereto does not exceed a predetermined distance threshold value.

In procedure 410, the real-time data point is classified an abnormal event. With reference to FIG. 2D, data point 248 is classified an abnormal event. With reference to FIG. 1, event detector 106 classifies the real-time data point an abnormal event.

In procedure 412, the real-time data point is classified a normal event. With reference to FIG. 2D, data points 242, 244 and 246 are classified normal events. With reference to FIG. 1, event detector 106 classifies the real-time data point a normal event.

As mentioned above, the event detector (e.g., event detector 106 of FIG. 1) detects an event by determining the distance between a real-time data measurement and a respective selected adjacent k^{th} measurement. In case the distance between the real-time measurement and the respective selected adjacent k^{th} measurement does not correspond to a RW motion pattern (e.g., the distance exceeds a step size threshold, also referred to as a distance threshold for K^{th} adjacency), the real-time data measurement might be associated with an abnormal event. The following description in conjunction FIGS. 6A, 6B, 7, 8, 9, 10A, 10B, and 11, relates to the second data analysis method of the disclosed technique (i.e., the relative distance data analysis method), for identifying and classifying events in a supply system. As also noted above, in order to perform the relative distance data analysis method, each of the data measurements has to be associated with a respective unique identifier in a sortable list of unique identifiers, such as a time stamp, so that the data measurements can be ordered.

The event management and detection system of the disclosed technique can independently employ either of the data analysis methods for detecting and for classifying events in the supply system. Alternatively, the event management and detection system can employ both methods and combine the results for improving the accuracy of the event classification. For example, in case a real-time data measurement is associated with an abnormal event according to one of the methods and is associated with a normal event according to the other method, the event detection system determines that the detected event is a normal event, thereby avoiding a false alarm of an abnormal event.

Reference is now made to FIGS. 6A and 6B. FIG. 6A is a schematic illustration of a normalized attribute space, generally referenced 450, constructed in accordance with another embodiment of the disclosed technique. FIG. 6B is a schematic illustration of the normalized attribute space of FIG. 6A having two groups of data measurements.

In the example set forth in FIG. 6A, attribute space 450 includes two dimensions (i.e., corresponding to the values of two attributes of the supply system). Depicted in attribute space 450 are seven data measurements, denoted by T₁, T₂, T₃, T₄, T₅, T₆ and T₇, which were acquired consecutively (i.e., data measurement T₁ was acquired first and data measurement T₇ was acquired last)_{.}

In the example set forth in FIG. 6A, the coordinates of data measurement T₁ are (7,4). That is the value of the first attribute, represented by the vertical axis, is seven and the value of the second attribute, represented by the horizontal axis, is four. The coordinates of data measurement T₂ are (8,6). The coordinates of data measurement T₃ are (8,12). The coordinates of data measurement T₄ are (5,10). The coordinates of data measurement T₅ are (3,8). The coordinates of data measurement T₆ are (4,16). The coordinates of data measurement T₇ are (7,14).

Event detector 106 (FIG. 1) determines the distance between each real-time measurement T_{N} and a respective selected preceding K^{th} measurement T_{N-K} in attribute space 450. For example, when K=3, Event detector measures the distance between the following pairs of measurements: T₄ and T₁, T₅ and T₂, T₆ and T₃, and T₇ and T₄. Accordingly, the Euclidean distance between T₄ and T₁ (i.e., N=4) is: D(T₄−T₁)=\sqrt{(5−7)²+(10−4)²}=\sqrt{140}. The Euclidean distance between T₅ and T₂ (i.e., N=5) is: D(T₅−T₂)=\sqrt{(3−8)²+(8−6)²}=\sqrt{29}. The Euclidean distance between T₆ and T₃ (i.e., N=6) is: D(T₆−T₃)=\sqrt{(4−8)²+(16−12)²}=\sqrt{32}. The Euclidean distance between T₇ and T₄ (i.e., N=7) is: D(T₇−T₄)=\sqrt{(7−5)²+(14−10)²}=\sqrt{20}.

It is noted that the distance between data measurements in attribute space 450 can be measured by various distance metrics, such as Euclidean distance, squared Euclidean distance, Manhattan distance, and the like. Additionally, the distance between data measurements may also be measured using the Square Estimated Euclidean Distance (SEED) as detailed herein below with reference to FIG. 3. Alternatively, the distance is determined as the average distance of a plurality of distance metrics.

The selected preceding K^{th} measurement T_{N-K}, or more specifically the time difference K, is selected such that the distance between the real-time measurement and the selected preceding measurement is minimal, as detailed further herein below with reference to FIG. 8. Alternatively, the difference K is replaced with a serial number difference K, or with the difference in the value of another unique identifier.

As mentioned herein above with reference to FIG. 1, according to the disclosed technique, the values of distances D(T_{N}−T_{N-K}), D(T_{N+1}−T_{N-K+1}), and so forth, correspond to a distributional RW motion pattern. Thus, by selecting the preceding measurement, which corresponds to a minimal distance between measurements, any deviation from the RW motion pattern is more discernable. That is, the relative magnitude of the deviation with respect to the RW motion pattern is maximal.

After determining the distances of each real-time measurement from the respective selected preceding K^{th} measurement T_{N-K}, event detector 106 produces a “pair distance versus time stamp” graph representing these distances versus the time (i.e., time stamp), as detailed further herein below with reference to FIG. 7.

In the example set forth in FIG. 6B, depicted in attribute space 450 are eleven data measurements, denoted by T₁₁, T₁₂, T₁₃, T₁₄, T₁₅, T₁₆, T₁₇, T₁₈, T₁₉, T₂₀, and T₂₁, which were acquired consecutively (i.e., data measurement T₁₁ was acquired first and data measurement T₂₁ was acquired last). As can be seen from attribute space 450, measurements T₁₁, T₁₂, T₁₃, T₁₄, T₁₅, and T₂₁ are all grouped at the bottom right corner of attribute space 450. As can be additionally seen from attribute space 450, measurements T₁₆, T₁₇, T₁₈, T₁₉, and T₂₀ are all grouped at the top left corner of attribute space 450. Thus, all of data measurements T₁₁, T₁₂, T₁₃, T₁₄, T₁₅, and T₂₁ have similar values of attributes. All of data measurements T₁₆, T₁₇, T₁₈, T₁₉, and T₂₀ have similar values of attributes, which are different from the values of measurements T₁₁, T₁₂, T₁₃, T₁₄, T₁₅, and T₂₁.

In the example set forth in FIG. 6B, measurements T₁₁, T₁₂, T₁₃, T₁₄, T₁₅, and T₂₁ are considered as the normal measurements, having normal values of attributes. That is, measurements T₁₁, T₁₂, T₁₃, T₁₄, T₁₅, and T₂₁ are classified normal events. On the other hand, measurements T₁₆, T₁₇, T₁₈, T₁₉, and T₂₀ have abnormal or exceptional values and therefore may be associated with an abnormal event. It is noted that, measurement T₂₁ marks the end of the event associated with measurements T₁₆, T₁₇, T₁₅, T₁₉, and T₂₀ and a return to normal measurements.

Reference is now made to FIG. 7, which is a schematic illustration of a “pair distance versus time stamp” graph, generally referenced 500, plotting the distance between a real-time measurement and a respective selected preceding K^{TH} measurement versus the time stamp value of the real-time measurement, constructed in accordance with a further embodiment of the disclosed technique. “Pair distance versus time stamp” graph 500 is a two dimensional graph in which the vertical axis represents the determined distance between two data measurements T_{N} and T_{N-K} in an attribute space, and the horizontal axis represents the acquirement time (or the serial number) of the more recent data measurement T_{N}. Alternatively, “pair distance versus time stamp” graph is replaced with a “pair distance versus unique identifier” graph showing the distance between adjacent pair of data instances versus the value of the respective unique identifier of one data instance of the adjacent pair of data instances. It is noted that “pair distance versus time stamp” graph 500 (i.e., and the relative distance data analysis method of the disclosed technique) relates to the magnitude of the relative position between pairs of measurements. In other words, the relative distance data analysis method relates to the size of a step D(T_{N}−T_{N-K}) of the RW motion pattern, and not to the direction of the step. For example, in case the only attribute of a water supply system is the temperature of water, the relative distance data analysis method analyses the temperature difference between a pair of measurements and does not relate to whether the temperature has risen or fallen over time.

In the example set forth in FIG. 7 there are four substantially flat (i.e., plateau) portions 502, 506, 510 and 514 and four peaks 504, 508, 512 and 516. The vertical axis represents the distance between a pair of data measurements, and the peak portions represent data measurements which are located away from preceding data measurements. The different location in the attribute space indicates that at least one of the attributes of the data measurements substantially changed (e.g., a rise in water temperature and salinity) during the time difference K between the measurements.

Plateau portions 502, 506, 510 and 514 of “pair distance versus time stamp” graph 500 are associated with data measurements, which exhibit similar attributes to preceding measurements. In this manner, an event, which changes at least some of the attributes of the data measurements, is associated with a peak followed by a plateau in “pair distance versus time stamp” graph 500. That is, the first few measurements associated with an event are represented by a peak in the “pair distance versus time stamp” graph, as their values of attributes are different from those of preceding normal measurements. The following measurements associated with the same event are represented by a plateau in the “pair distance versus time stamp” graph, as their values of attributes are similar to the first measurements associated with the same event. A following peak in “pair distance versus time stamp” graph 500 represents another change in the location of the measurements, which can be associated with a return to normal values (i.e., when the height of the first and the second peaks is substantially similar).

For example, in FIG. 6B, measurements T₁₁, T₁₂, T₁₃, T₁₄, and T₁₅, are associated with a plateau. Measurements T₁₆, T₁₇, T₁₈, T₁₉, and T₂₀ are associated with a peak and a following plateau. In case K=3, the distances D(T₁₆₋₁₃), D(T₁₇₋₁₄) and D(T₁₈₋₁₅), are associated with a peak in “pair distance versus time stamp” graph 500, and measurements T₁₉ and T₂₀ are associated with a following plateau. Measurement T₂₁, which marks a return to normal attribute values, is associated with another peak in “pair distance versus time stamp” graph 500 marking the end of the event. In the example set forth in FIG. 7, the measurements associated with first plateau portion 502 are considered as measurements having normal attribute values (i.e., normal measurements).

The measurements associated with first peak portion 504 and with second plateau portion 506 are all located in the same vicinity in the attribute space, and are associated with a first event 518. The location of the measurements associated with first event 518 in the attribute space is different from the location of the normal measurements (i.e., associated with first plateau portion 502).

The measurements associated with second peak portion 508 and with third plateau portion 510 are all located in the same vicinity in the attribute space. The height of first peak 504 and second peak 508 is substantially similar. Second peak 508 might indicate that the average location of the data measurements (i.e., measurements associated with second peak portion 508 with second plateau 510) has returned to the location of the normal data measurements. Thus, first event 518 begins with first peak 504 and ends with second peak 508.

In a similar manner, second event 520 begins with third peak 512 and ends with fourth peak 516. That is, measurements associated with third peak 512 and with fourth plateau portion 514 are associated with second event 520. Note that as the height of first peak 504 is different than the height of third peak 512, first event 518 and second event 520 are not associated with a similar event (i.e., a similar change on the values of the attributes of the measurements).

Event detector classifies each event as either a normal event or an abnormal event at least according to at least one of the parameters of the peak portion of “pair distance versus time stamp” graph 500. Such parameters include the height of the peak portion marking the beginning of an event, the slope thereof, the width at half height thereof, skewness and the like.

In the example set forth in FIG. 7, the height of first peak 504 is H₁ and the height of third peak 512 is H₂. The height of a peak portion representing an event, must exceed a selected step size threshold, which is associated with a RW motion pattern, in order for the event to be classified as an abnormal event, as detailed further herein below with reference to FIG. 9.

In the example set forth in FIG. 7, the slope of first peak 504 is α and the slope of third peak 512 is β. The slope of a peak portion representing an event may indicate a malfunction in the sensor units. The slope of the peak represents the rate of changes in the values of the attributes of the data measurements. In particular, a rapid change in the values of attributes is associated with a steep slope, and a slow change is associated with a moderate slope. In case the slope angle (i.e., or the slope derivative) exceeds a pre-determined threshold, the rate of changes in the values of the attributes may be too high to be realistically explained by an event in the supply system, and is therefore associated with a sensor malfunction. The threshold of the slope of the peak, for indicating sensor malfunction is determined according to the measured attributes and is further determined according to the physical supply system.

For example, voltage output of a solar cell coupled with an electrical grid can change rapidly due to clouds obscuring the sun. Thus, in case the voltage production of a solar cell decreases by half in two minutes, it might be associated with obscuring clouds and not with a sensor malfunction. On the other hand, the attributes of a large water reservoir changes slowly. Thus, in case the temperature of a water reservoir storing 10,000 cubic meters of water, increases by 50% in two minutes, the temperature measurement sensor may be faulty, as the energy required for such a temperature change cannot realistically be provided in the measured time.

The more attributes a data measurement includes, the less discernible is a change in a single attribute. Additionally, some types of supply system events are associated with specific attributes. For example, an abnormal event of an organic poisoning is associated with a first set of attributes and has substantially no affect on other attributes. Thus, for detecting a selected type of event, the event detector can produce a designated “pair distance versus time stamp” graph, which corresponds only to a selected set of attributes, which is associated with the selected type of event. Table 1 herein presents some water supply system events and corresponding sets of attributes, which are monitored for detecting these events:

TABLE 1

| Event | Alk | Con | Chl | NO3 | ORP | pH | Tur | UV254 | Hard | Tem |
|---|---|---|---|---|---|---|---|---|---|---|
| Organic | | + | + | | + | | + | + | | |
| poisoning | | | | | | | | | | |
| Inorganic | + | + | + | | + | + | + | + | + | |
| poisoning | | | | | | | | | | |
| Sewage | + | + | + | + | + | + | + | + | + | |
| Pipe | | | + | | | | + | | | + |
| burst | | | | | | | | | | |

Wherein Alk is alkalinity; Con is conductivity; Chl is chlorine; NO3 is nitrate; ORP is oxidation reduction potential; pH is pondus Hydrogenii; Tur is turbidity; UV254 is measurement of UV optical density at 254 nm; Hard is hardness and Tem is Temperature.

Furthermore, the weight of each of the attributes in the attribute space can be modified. Thus, attributes associated with selected types of events can become more prominent when projecting the data measurements onto the attribute space, for better identifying the corresponding events. The weight of the attributes can be modified by determining the resolution at which the attribute is measured. Alternatively, the weight of the attributes can be modified by multiplying the respective value of each attribute, in each of the measurements, with a respective weighting factor. The weighting factor respective of each attribute is determined according to the type of the abnormal event to be detected.

Additionally, event detector 106 (FIG. 1) can further classify an event according to additional information relating to the supply system. Additional information relating to the supply system can be, for example, management operations of the supply system (e.g., adding a disinfectant to a water reservoir) and information about a malfunction in a facility of the supply system. Additional information can further relate to the classification of the data measurement as an abnormal event according to the clustering data analysis method, as detailed herein above with reference to FIGS. 2A, 2B, 2C, 2D, 3, 4, and 5.

For example, the event detection and management system classifies a data measurement as an abnormal event according to the relative distance method. The event system determines that the same data measurement is associated with a known cluster according to the clustering method, and therefore is classified as a normal event. In this case, the event system classifies that data measurement as a normal event and avoids a false abnormal event alarm. That is, even though the distance between the real-time data measurement and the adjacent data measurement exceeds the predetermined step size threshold, as the location of the real-time data measurement is associated with a known cluster, the measurement is associated with a normal event. The known cluster can be associated, with a normal event, such as adding disinfectant to the water reservoir of a water supply system.

Reference is now made to FIG. 8, which is a schematic illustration of a “distance versus time difference” graph, generally referenced 550, representing the distance between a selected pair of data measurements versus the time difference (i.e., the time stamp difference) between the selected measurements, constructed in accordance with another embodiment of the disclosed technique. The vertical axis of “distance versus time difference” graph 550 represents the distance between a selected pair of data measurements D(T_{N}-T_{N-K}), and the horizontal axis represents the time difference between the data measurements K. That is, “distance versus time difference” graph 550 diagrammatically represents the mapping between the distance and the difference in the time stamp values between a selected pair of data measurements (T_{N}, T_{N-K}). Alternatively, “distance versus time difference” graph is replaced with a “distance versus unique identifier value difference” graph showing the distance between adjacent pair of data instances versus the difference in the values of the respective unique identifier between the data instances.

“Distance versus time difference” graph 550 is constructed empirically according to the data measurements within the database (e.g., database 108 of FIG. 1) of the event detection and management system (e.g., system 100 of FIG. 1). That is the event detector (e.g., event detector 106 of FIG. 1) determines the distance between measurements of selected pairs of data measurements and produces “distance versus time difference” graph 550 accordingly. The event detector can update “distance versus time difference: graph 550 according to additional selected pairs of data measurements (e.g., new real-time data measurements).

As can be seen, “distance versus time difference” graph 550 has a descending portion 552, an ascending portion 554 and a minimum point 556. That is, along descending portion 552, as the time difference K increases, the distance between a selected pair of data measurements decreases. Along ascending portion 554, the distance between a selected pair of data measurements increases with the time difference K. At the minimum point 556, the distance between the selected pair of measurements is minimal ‘Dₘᵢₙ’.

The event detection system determines the time difference at minimum point 556 ‘K(Dₘᵢₙ)’ (i.e., the time coordinate of minimum point 556) either manually or automatically, according to “distance versus time difference” graph 550. The event detection system employs K(Dₘᵢₙ) for determining the distance D(T_{N}−T_{N-Kmin}) for identifying events in the supply system according to real-time measurements. By employing K(Dₘᵢₙ) as the time difference between the selected pair of data measurements, the distance between the selected pair of data measurements is minimal, thereby any deviation from a RW motion pattern is more discernible. That is, the event detection system determines the time difference K as the time difference exhibiting (i.e., corresponding to) the minimum distance according to “distance versus time difference” graph 550. That is, the event detection system determines the unique identifier value difference K as the value difference exhibiting (i.e., corresponding to) the minimum distance according to “distance versus unique identifier value difference” graph.

Reference is now made to FIG. 9, which is a schematic illustration of a “probability versus distance” graph, generally referenced 600, representing the distribution (i.e., frequency) of probabilities of being at a selected distance from the location of a selected data measurement after a predetermined time period, constructed in accordance with another embodiment of the disclosed technique. The pre-determined time period, can be for example, K(Dₘᵢₙ), determined as detailed herein above with reference to FIG. 8. That is, “probability versus distance” graph 600 diagrammatically represents the mapping between the probability of being at a selected distance from the location of a selected data measurement after a predetermined time period and the selected distance.

“Probability versus distance” graph 600 relates to an absolute distance from the point of origin (i.e., as opposed to the traveled distance, such as the commute distance), which is a selected data measurement. The vertical axis of “probability versus distance” graph 600 represents the probability of being at a specific distance from the location of the selected data measurement (i.e., from the point of origin), and the horizontal axis represents the distance.

“Probability versus distance” graph 600 is constructed empirically according to the data measurements stored within the database (e.g., database 108 of FIG. 1) of the event detection and management system (e.g., system 100 of FIG. 1). That is the event detector (e.g., event detector 106 of FIG. 1) determines the probability of being positioned at an absolute distance from a selected data measurement after a predetermined constant period of time. The event detector produces “probability versus distance” graph 600 empirically from the data measurements stored in the database.

As can be seen, “probability versus distance” graph 600 has an ascending portion 602, a descending portion 604 and a maximum point 606. Along ascending portion 602, as the distance increases, the probability of being positioned at that distance increases. Along descending portion 604, as the distance increases, the probability of being positioned at that distance decreases. Maximum point 606 ‘D_{most probable}’ (i.e., the distance coordinate of maximum point 606), represents the most probable distance from the point of origin.

The event detection system analyzes “probability versus distance” graph 600 and accordingly determines a step size threshold for the distance between a pair of data measurements in the “pair distance versus time stamp” graph. When the distance between a data measurement and a K^{th} adjacent measurement D(T_{N}−T_{N-K}), exceeds the step size threshold, the event detection system classifies the data measurement T_{N} as beginning a new event, which might be an abnormal event.

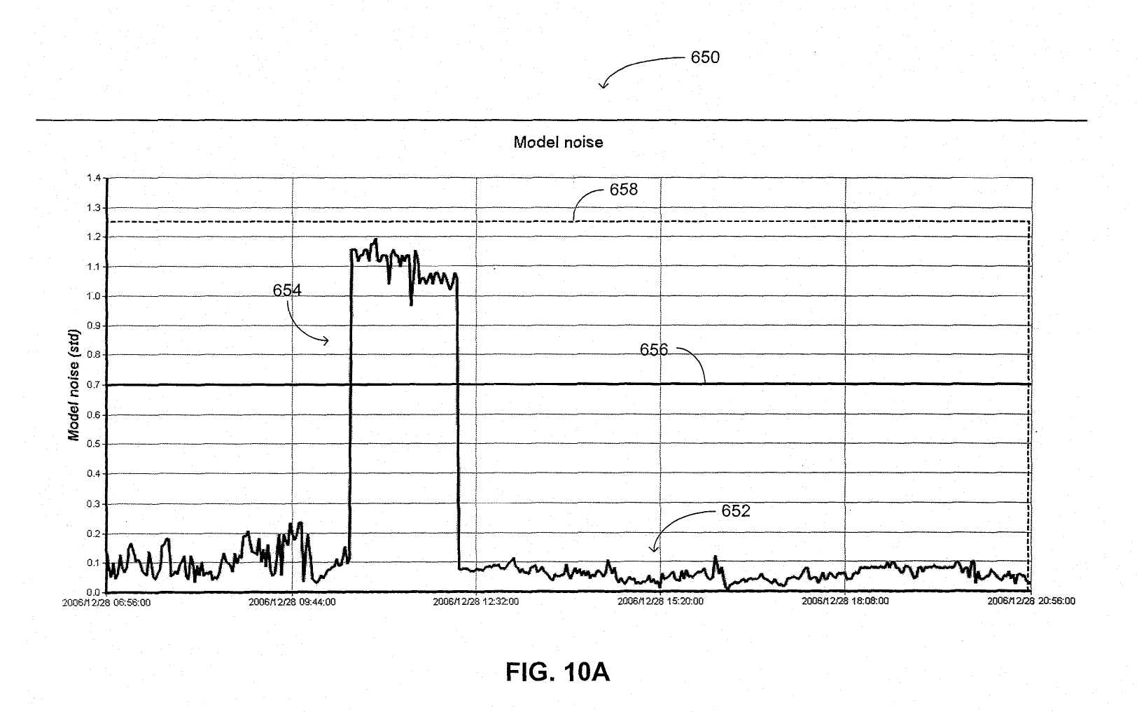

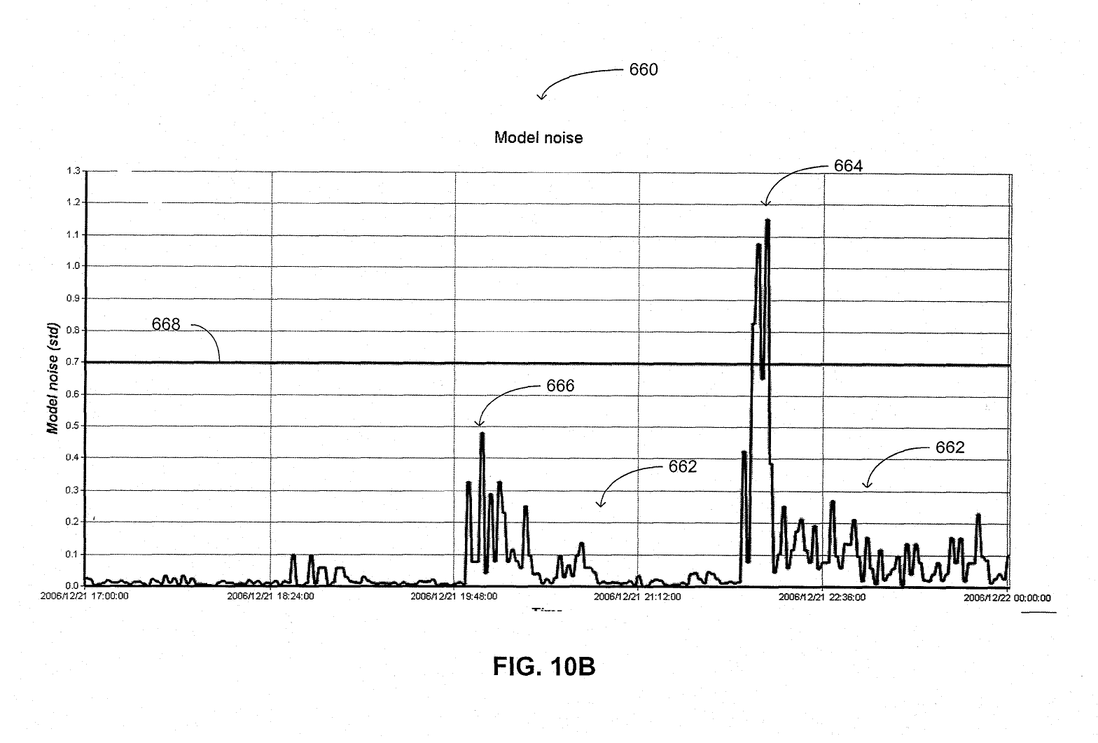

For example, the step size threshold is set according to the type of distribution of the RW motion pattern. In case the RW motion pattern corresponds to a distribution with a known shape, the first moment of the distribution is defined as the center, and the step size threshold is set as 3 times the second moment of the distribution. In accordance with another example, the event detection system sets the threshold to be three times the most probable distance. Thus, the event detection system determines the step distance threshold according to the distance, which exhibits the maximum probability according to “probability versus distance” graph 600. In other words, the event detection system determines the step distance threshold according to the most probable distance according to “probability versus distance” graph 600. Reference is now made to FIG. 10A, which is a schematic illustration of a “pair distance versus time stamp” graph, generally referenced 650, including a malfunctioning sensor event, constructed in accordance with a further embodiment of the disclosed technique. “Pair distance versus time stamp” graph 650 includes a graph curve 652 and a threshold distance 656. Curve 652 includes a peak 654, which height exceeds distance threshold 656. The event detection system identifies peak 654 as an event.

As mentioned above, in case the slope angle (i.e., slope derivative) of a peak of a “pair distance versus time stamp” graph 650 exceeds a pre-determined slope threshold, the peak is identified as a sensor malfunction event. As can be seen from FIG. 10A, the slope of peak 654 is substantially vertical (i.e., having a slope angle of approximately 90° degrees). Thus, the slope of peak 654 indicates a rapid change in the values of attributes of the associated data measurements. In the example set forth in FIG. 10A, peak 654 is classified as a sensor malfunction and not as a real water event.

Alternatively, a sensor malfunction can be detected according to the ratio between a rectangle 658, circumscribing the curve of “pair distance versus time stamp” graph 650, and the area bounded by the curve and the X-axis. In case this ratio exceeds a predetermined value, the sensors are considered as malfunctioning.

Reference is now made to FIG. 10B, which is a schematic illustration of a “pair distance versus time stamp” graph, generally referenced 660, including a water event, constructed in accordance with another embodiment of the disclosed technique. “Pair distance versus time stamp” graph 660 includes a graph curve 662 and a threshold distance 668. Curve 662 includes a first peak 664 and a second peak 666.

The height of first peak 664 exceeds distance threshold 668. The event detection system identifies peak 664 as an event. The shape and the slope of peak 664 might indicate that the event associated therewith is a water supply event. That is, the slope angle of peak 664 does not exceed the pre-determined slope threshold for identifying a sensor malfunction. The height of second peak 666 does not exceed distance threshold 668 and therefore second peak 666 is not identified as an event.

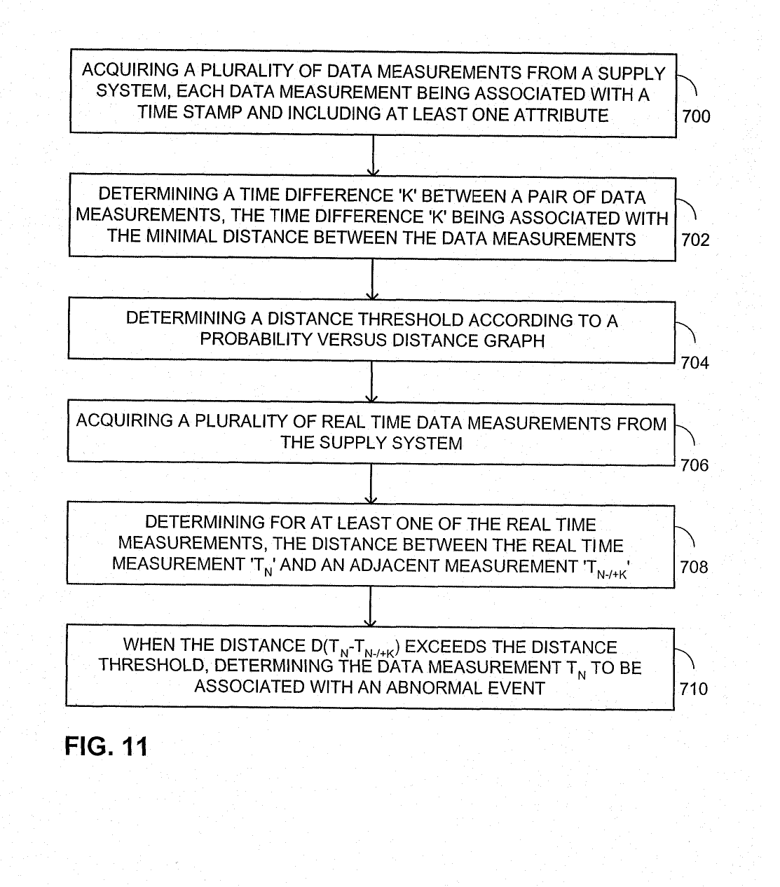

Reference is now made to FIG. 11, which is a schematic illustration of a method for detecting and classifying events in a supply system, operative in accordance with a further embodiment of the disclosed technique. In procedure 700, a plurality of data measurements from a supply system are acquired. Each of the data measurements includes at least one attribute and is associated with a time stamp. With reference to FIG. 1, each one of sensor units 102₁, 102₂, 102₃, 102₄ . . . 102_{N} acquires a plurality of data measurements from the respective sensors thereof. The term ‘measurement’ refers to a vector of attributes provided to event detector 106 by sensor units 102₁ to 102_{N}. Additionally, each of the data measurements is associated with a time stamp detailing the acquirement time of the respective measurement. Sensor units 102₁ to 102_{N} provide the measured data to event detector 106.

In procedure 702, a time difference K between a pair of data measurements is determined. As mentioned above, the time difference K is associated with the minimal distance between the data measurements. With reference to FIGS. 1 and 8, event detection system 100 determines the time difference K(Dₘᵢₙ) either manually or automatically. The time difference K, is selected such that the distance between the measurements (i.e., the real-time measurement and the selected adjacent measurement) is minimal. Thereby, any deviation from the RW motion pattern of the distances between measurements of selected pairs is more discernible as its magnitude relative to the distance is larger.

In procedure 704, a distance threshold, above which the real-time data measurement may be associated with an abnormal event, is determined according to a “probability versus distance” graph of distances from the point of origin. With reference to FIGS. 1 and 9, event detection system 100 determines the distribution function of the distances, from the point of origin after a predetermined period of time, for the RW motion pattern of the data measurements. Event detection system 100 determines a distance threshold (i.e., step size threshold or distance threshold for K^{th} adjacency) between a data measurement and a selected adjacent measurement according to the distance distribution function (i.e., according to the “probability versus distance” graph). In case the distance between a real-time data measurement and a selected adjacent measurement exceeds the distance threshold, the real-time measurement may be associated with an abnormal event.

In procedure 706, a plurality of real-time data measurements from the supply system are acquired. With reference to FIG. 1, each one of sensor units 102₁, 102₂, 102₃, 102₄ . . . 102_{N} acquires a plurality of real-time data measurements from the respective sensors thereof.

In procedure 708, for at least one of the real-time measurements, the distance between the real-time measurement T_{N} and a adjacent measurement T_{N-/+K} is determined. With reference to FIG. 1, for at least one of the real-time data measurements, event detector 106 determines the distance between the real-time measurement and a selected adjacent measurement.

in procedure 710, in case the distance D(T_{N}−T_{N-,+K}) exceeds the distance threshold, the data measurement T_{N} is determined to be associated with an event. The event is further classified as either a normal event or an abnormal event at least according to the distance between a real-time data measurement associated with the event and a adjacent data measurement. The event can further be classified according to Additional information relating to the supply system.

With reference to FIG. 1, Event detector 106 identifies a real-time data measurement, or a sequence of measurements, as an abnormal event according to the distance of the measurement from the adjacent measurement. In particular, Event detector 106 identifies a real-time data measurement, or a sequence of measurements, as an event when the distance from adjacent data measurements exceeds a pre-determined step size threshold.

Additionally, event detector 106 can further classify an event according to additional information relating to the supply system. For example, the additionally information can relate to various parameters of the produced “pair distance versus time stamp” graph, such as the ratio between a circumscribing rectangle and the area bound between the curve and the X-axis.

Additional information relating to the supply system can be, for example, management operations of the supply system (e.g., adding a disinfectant to a water reservoir) and information about a malfunction in a facility of the supply system. Additional information can further relate to the classification of the data measurement as an abnormal event according to the clustering data analysis method, as detailed herein above. As mentioned above the event detection and management system of the disclosed technique can detect and classify an event in the supply system by analyzing data measurements from a plurality of sensors associated with the event system. The system detects events either by employing the clustering method (as detailed herein with reference to FIGS. 2-5), employing the relative distance method (as detailed herein with reference to FIGS. 6-11), or employing a combination of both these methods (i.e., combining the results of both methods). Once an event is classified as an abnormal event, data relating to the event (e.g., time and location of the event) is transferred to various subsystems, which facilitate the management of the event (e.g., communicating the information relating to the event to emergency services and pertinent personal).

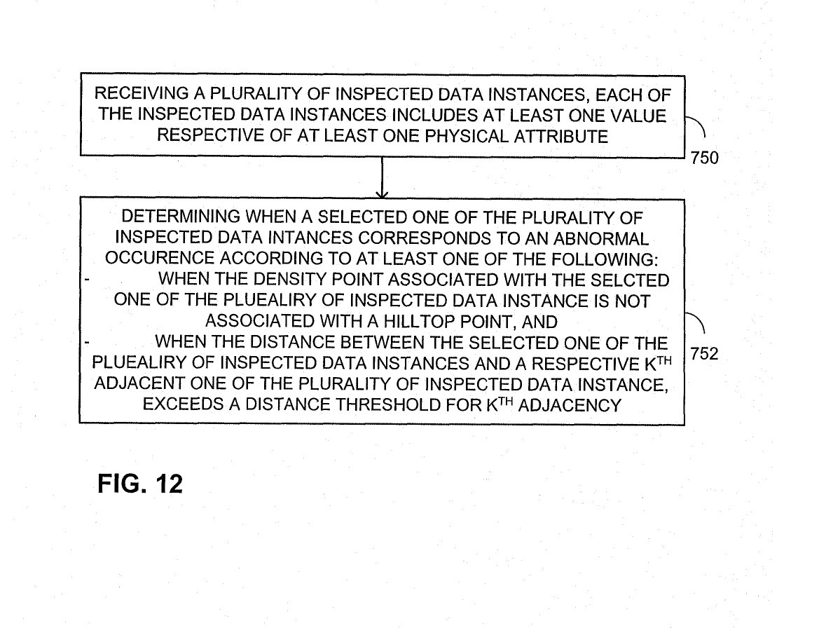

Reference is now made to FIG. 12, which is a schematic illustration of a method for detecting abnormal events. In procedure 750, a plurality of inspected data instances is received. Each of the plurality of inspected data instances includes at least one value respective of at least one physical attribute. As mentioned above, these attributes are, for example, acidity (pondus Hydrogenii—pH), temperature, conductivity, Total Organic Carbon (TOC), residual chlorine, alkalinity; nitrate (NO₃); Oxidation Reduction Potential (ORP); turbidity; UV optical density at 254 nm (UV254); hardness, pressure, flow rate and the like. With reference to FIG. 1, event detection system includes a plurality of sensor units 102₁, 102₂, 102₃, 102₄ . . . 102_{N}, each including a plurality of respective sensors such as sensors 120₁ . . . 120_{M}. Each of sensor units 102₁, 102₂, 102₃, 102₄ . . . 102_{N} acquires a plurality of real-time data measurements from the respective sensors thereof.

In procedure 752, it is determined when a selected one of the plurality of inspected data instances corresponds to an abnormal event according to at least one of the following:
when the density point associated with the selected one of the plurality of inspected data instances is not associated with a hilltop point, and
when the distance between the selected one of the plurality of inspected data instances and a respective K^{th} adjacent one of the plurality of inspected data instances, exceeds a distance threshold for K^{th} adjacency.
   A hilltop point is defined at least when the density value of a density point, is larger than the density values of density points at most a predetermined distance from the density point, by a predetermined value.

As can be seen in FIG. 12 and the corresponding description thereof, the abnormal occurrence detection method employs one of two analysis methods, a hilltop method and a relative distance method, or a combination of both methods. The hilltop method is described herein above in conjunction with to FIGS. 2-5. The relative distance method is described herein in conjunction with FIGS. 6-11. It will be appreciated by persons skilled in the art that the disclosed technique is not limited to what has been particularly shown and described hereinabove. Rather the scope of the disclosed technique is defined only by the claims, which follow.

1. An abnormal occurrence detection system comprising:
an abnormal occurrence detector, said abnormal occurrence detector inspecting a plurality of inspected data instances, each one of said plurality of inspected data instances including values associated with at least one physical attribute, said values defining the location of each data instance in an attribute space, at least some of the dimensions of said attribute space being each associated with respective one of said at least one physical attribute, said abnormal occurrence detector detecting when at least one data instance corresponds to an abnormal occurrence according to at least one of the following:
when a density point associated with one of said inspected data instances is not associated with one of at least one hilltop point, said density point being defined as a location in said attribute space, associated with a value representing the number of analyzed data instances in a predefined area around said location, said at least one hilltop point being defined at least when the density value of a density point, is larger than the density values of density points at most a predetermined distance from said density point, by a predetermined value; and
when the distance in said attribute space, between a selected one of said plurality of inspected data instances associated with a first respective unique identifier in a sorted list of unique identifiers and a respective K^{th} adjacent one of said plurality of inspected data instances associated with a second respective unique identifier in said sorted list of unique identifiers, exceeds a distance threshold for K^{th} adjacency, said sorted list of unique identifiers defining a sorted sequence of data instances, said respective K^{th} adjacent one of said plurality of inspected data instances being K entries away from said selected one of said plurality of inspected data instances in said sorted sequence of data instances; and
a database, coupled with said abnormal occurrence detector, for storing data instances.

2. The system according to claim 1 wherein, said abnormal occurrence detection system detects abnormal events in a supply system, said abnormal occurrence detection system further includes at least one sensor unit, each of said at least one sensor unit including at least one respective sensor, each of said at least one respective sensor measuring at least one respective one of said at least one physical attribute, each of said at least one sensor units acquiring an inspected data instance from said at least one respective sensor thereof,
wherein each sensor unit acquires a plurality of inspected data instances,
wherein said abnormal occurrence detector is an event detector, said event detector projects the inspected data instances onto said attribute space thereby defining data points,
wherein said event detector determines a grid for said attribute space, said grid partitioning each dimension of said attribute space into a plurality of sections, the intersections of the grid lines defining a plurality of grid points,
wherein said event detector determines a respective cell around each grid point,
wherein said event detector determines, for each cell, a respective density value according to the number of data points within said cell associated, thereby defining a respective density point, and
wherein said event detector further associates each of the remaining density points with a respective one of said at least one hilltop point, said respective one of said at least one hilltop point being the closest hilltop to the density point, and the density gradient at the location of said density point in said attribute space, increases toward said closest hilltop point.

3. The system according to claim 2, wherein said event detector projects an inspected data instance onto said attribute space thereby defining an inspected data point, said event detector associates said inspected data point with the closest density point thereto, said event detector further classifies said inspected data point as an abnormal event when one of the following occurs:
The density value of said density point associated with said inspected data point does not exceed a predetermined density threshold value; and
The distance of said inspected data point, from a hilltop point, exceeds a predetermined distance threshold value.

4. The system according to claim 1, wherein said at least one hilltop point is further defined when there are a minimum number of grid points around said density point, and
wherein said at least one hilltop point is located at least a predetermined distance from any other one of said at least one hilltop point in said attribute space.

5. The system according to claim 2, wherein said density gradient is estimated by determining the average density in the quadrilateral defined by said density point and said respective one of said at least one hilltop point,
wherein, when said average density is higher than the density value of said density point, then said gradient is determined as increasing and said density point is associated with said respective one of said at least one hilltop point, and
wherein, when said average density is lower than said density value of said density point, then the gradient is determined as decreasing and the next closest hilltop point is searched.

6. The system according to claim 1, wherein said distance is estimated by the Square Equivalent Euclidean Distance,
wherein said Square Equivalent Euclidean Distance is defined by a hypercube, and
wherein a point on the rim of said hypercube is estimated to be a distance R from the center of said hypercube when the volume of said hypercube equals the volume hypersphere exhibiting a radius equal to said distance R.

7. The system according to claim 6, wherein when the number of dimensions is even, said Square Equivalent Euclidian Distance is determined by
$$SEED = \frac{R}{2} * \sqrt[n]{\frac{2 {π}^{n / 2}}{2 * 4 * … n}} ,$$
wherein, when the number of dimensions is odd, said Square Equivalent Euclidian Distance is determined by:
$$SEED = \frac{R}{2} * \sqrt[n]{\frac{2 * 2 {π}^{( n - 1 ) / 2}}{1 * 3 * … n}} ,$$
and
wherein n represents the number of dimensions.

8. The system according to claim 1 wherein said abnormal occurrence detector detects when at least one data instance corresponds to an abnormal occurrence by mapping between the distance, in said attribute space, of each of said plurality of inspected data instances from said respective K^{th} adjacent one of said plurality of inspected data instances and the value of the respective sortable unique identifier associated with said each of said plurality of inspected data instances.

9. The system according to claim 8, wherein said abnormal occurrence detector produces a “pair distance versus unique identifier” graph according to said mapping, said abnormal occurrence detector detects when at least one data instance corresponds to an abnormal occurrence according to at least one peak of said “pair distance versus unique identifier” graph.

10. The system according to claim 1, wherein a unique identifier value difference ‘K’ is defined as the difference between the value of said respective unique identifier of said selected one of said plurality of inspected data instances and the value of said respective unique identifier of said respective K^{th} adjacent one of said plurality of inspected data instances, and
wherein said abnormal occurrence detector determines said unique identifier value difference ‘K’ by mapping between the distance, in said attribute space, and the difference in the value of said respective unique identifier between a selected one of said analyzed data instances and each of at least a portion of adjacent ones of said analyzed data instances, said abnormal occurrence detector determining said unique identifier value difference ‘K’ as the difference in the value of said respective unique identifier corresponding to the minimal distance value.

11. The system according to claim 1, wherein said abnormal occurrence detector determining said distance threshold for K^{th} adjacency by mapping between a selected distance and the probability of being at said selected distance, in said attribute space, from a selected one of said analyzed data instances, said abnormal occurrence detector determining said distance threshold for K^{th} adjacency according to the most probable distance value.

12. The system according to claim 1, wherein each of said plurality of inspected data instances including values associated with a selected set of said at least one physical attribute and wherein said selected set of said at least one physical attribute is associated with a selected type of abnormal occurrence.

13. The system according to claim 1, wherein said abnormal occurrence detection system detects abnormal events in a supply system, said abnormal occurrence detector being an event detector, said abnormal occurrence detection system further including at least one sensor unit, each of said at least one sensor unit including at least one respective sensor, each of said at least one respective sensor measuring at least one respective one of said at least one physical attribute, each of said at least one sensor units acquiring an inspected data instance from said at least one respective sensor thereof.

14. The system according to claim 2, further including:
a Supervisory Control and Data Acquisition subsystem, coupled with said event detector and with at least one additional sensor unit other than said at least one sensor unit, said at least one additional sensor unit including at least one respective sensor, said Supervisory Control and Data Acquisition subsystem monitors and controls sites and infrastructure of said supply system according to measurements acquired from said at least one additional sensor unit, said Supervisory Control and Data Acquisition subsystem provides at least a portion of the measurements acquired thereby to said event detector;
an event monitoring and management system including:
a Customer Relationship Management (CRM) subsystem, said Customer Relationship Management subsystem receiving messages and tasks from customers, said Customer Relationship Management subsystem dynamically linking said messages to either one of detected events and new events;
emergency and crises management subsystem, enabling a user to control and monitor the operation of emergency resources;
a geographical information subsystem receiving information relating to the geographical location of mobile personal and equipment using tracking systems and providing said information to said user, geographical information subsystem further relating events to the geographical location thereof;
a business intelligence and debriefing subsystem for supporting business decision making, said business intelligence and debriefing subsystem aggregates information from said geographical information subsystem, said Customer Relationship Management subsystem, said Supervisory Control and Data Acquisition subsystem, from an Enterprise Resource Planning (ERP) subsystem, and from spreadsheets site access control subsystem, said business intelligence and debriefing subsystem performing analysis of the provided information, said business intelligence and debriefing subsystem further producing reports relating to the results of said analysis;
a video subsystem, for displaying visual information of sites and events; and
a distribution subsystem for receiving information from said event monitoring and management system and distributing said information.

15. The system according to claim 14, wherein said Supervisory Control and Data Acquisition subsystem further performs analysis of the measurements acquired from said at least one additional sensor and provides the results of this analysis to said event detector.

16. The system according to claim 14 wherein said Customer Relationship Management subsystem filters and prioritizes the received customer messages to prevent unnecessary allocation of resources, said Customer Relationship Management subsystem further analyzing the received messages and recommending a course of action, and
wherein said emergency and crises management subsystem further facilitates the recruitment of and the debriefing of emergency personal.

17. A method for detecting abnormal occurrences, the method comprising the procedures of:
acquiring a plurality of inspected data instances, each one of said plurality of inspected data instances including values associated with at least one physical attribute, said values defining the location of each data instance in an attribute space, at least some of the dimensions of said attribute space being each associated with respective one of said at least one physical attribute; and
detecting when at least one data instance corresponds to an abnormal occurrence according to at least one of the following:
when a density point associated with one of said inspected data instances is not associated with one of at least one hilltop point, said density point being defined as a location in said attribute space, associated with a value representing the number of analyzed data instances in a predefined area around said location, said at least one hilltop point being defined at least when the density value of a density point, is larger than the density values of density points at most a predetermined distance from said density point, by a predetermined value; and
when the distance in said attribute space, between a selected one of said plurality of inspected data instances associated with a first respective unique identifier in a sorted list of unique identifiers and a respective K^{th} adjacent one of said plurality of inspected data instances associated with a second respective unique identifier in said sorted list of unique identifiers, exceeds a distance threshold for K^{th} adjacency, said sorted list of unique identifiers defining a sorted sequence of data instances, said respective K^{th} adjacent one of said plurality of inspected data instances being K entries away from said selected one of said plurality of inspected data instances in said sorted sequence of data instances.

18. The method according to claim 17, wherein determining a hilltop point is determined according to the following sub-procedures of:
projecting a plurality of inspected data instances onto said attribute space;
determining a grid for said attribute space, said grid partitioning each dimension of said attribute space into a plurality of sections, the intersections of the grid lines defining a plurality of grid points;
determining a respective cell around each of said plurality of grid points;
for each cell, determining a density value according to the number of data points within said cell, thereby defining a respective density point; and
associating each of the remaining density points with a respective one of said at least one hilltop point, said respective hilltop point being the closest hilltop to the density point, and the density gradient at the location of said density point in said attribute space, increases toward said closest hilltop point.

19. The method according to claim 18, further including the procedure of:
determining an inspected data instance by projecting one of said inspected data instance onto said attribute space;
associating said inspected data instance with a respective density point;
determining whether said respective density point associated with said inspected data instance is associated with one of said at least one hilltop point; and
classifying said real-time data point as an abnormal occurrence at least when said respective density point associated with said real-time data point is not associated with one of said at least one hilltop point.

20. The method according to claim 19, wherein said real-time data point is further classified as an abnormal occurrence when one of the following occurs:
The density value of said density point associated with said inspected data instance does not exceeds a predetermined density threshold value; and
The distance of said inspected data instance, from one of said at least one hilltop point, exceeds a predetermined distance threshold.

21. The method according to claim 19, wherein the values of the attributes of each of said inspected data instance and said analyzed data instances are normalized.

22. The method according to claim 18, wherein said at least one hilltop point is further defined when there are a minimum number of grid points around said density point, and said at least one hilltop point is located at least a predetermined distance from any other of said at least one hilltop point in said attribute space.

23. The method according to claim 18, wherein said density gradient is estimated by determining the average density in the quadrilateral defined by said density point and said respective at least one hilltop point,
wherein, when said average is higher than the density value of said density point, then said gradient is determined as increasing and said density point is associated with said respective hilltop point, and
wherein, when said average is lower than said density value of said density point, then the gradient is determined as decreasing and the next closest one of said at least one hilltop point is searched.

24. The method according to claim 18, wherein the spacing between the grid lines, in each dimension in said attribute space, is determined according to the normalized standard deviation of the attributes respective of that dimension.

25. The method according to claim 24, wherein said spacing between the grid lines, in each dimension in said attribute space, is determined according to a function of the standard deviation of the attributes respective of that dimension.

26. The method according to claim 25, wherein said function is the logarithm of the standard deviation.

27. The method according to claim 24, where in the spacing between said grid lines in each dimension may be different for each different dimension.

28. The method according claim 17, wherein said distance is estimated by the Square Equivalent Euclidean Distance,
wherein said Square Equivalent Euclidean Distance is defined by a hypercube, and
wherein a point on the rim of said hypercube is estimated to be a distance R from the center of said hypercube when the volume of said hypercube equals the volume hypersphere exhibiting a radius equal to said distance R

29. The method according to claim 21, wherein when the number of dimensions is even, said Square Equivalent Euclidian Distance is determined by
$$SEED = \frac{R}{2} * \sqrt[n]{\frac{2 {π}^{n / 2}}{2 * 4 * … n}} ,$$
wherein, when the number of dimensions is odd, said Square Equivalent Euclidian Distance is determined by:
$$SEED = \frac{R}{2} * \sqrt[n]{\frac{2 * 2 {π}^{( n - 1 ) / 2}}{1 * 3 * … n}} ,$$
and
wherein n represents the number of dimensions.

30. The method according to claim 17, wherein each of said plurality of inspected data instances and each of said analyzed data instances is associated with a respective unique identifier, and wherein said procedure of detecting when at least one data instance corresponds to an abnormal occurrence further comprises the procedures of:
determining for at least one of said plurality of inspected data instances, the distance from said respective K^{th} adjacent one of said plurality of inspected data instances, wherein X′ being a unique identifier value difference said unique identifier value difference ‘K’ is defined as the difference between the value of said respective unique identifier of said selected one of said plurality of inspected data instances and the value of said respective unique identifier of said respective K^{th} adjacent one of said plurality of inspected data instances; and
classifying said at least one of said plurality of inspected data instances as an abnormal occurrence at least according to the determined distance from said respective K^{th} adjacent one of said plurality of inspected data instances and according to said distance threshold for K^{th} adjacency.

31. The method according to claim 30, wherein when the determined distance of said at least one of said plurality of inspected data instances from said respective K^{th} adjacent one of said plurality of inspected data instances exceeds said distance threshold for K^{th} adjacency, classifying said at least one of said plurality of inspected data instances as an abnormal occurrence.

32. The method according to claim 30, wherein said procedure of classifying said at least one of said plurality of inspected data instances as an abnormal occurrence includes the sub-procedure of mapping between the distance, in said attribute space, of each of said plurality of inspected data instances from said respective K^{th} adjacent one of said plurality of inspected data instances and the value of the respective sortable unique identifier associated with said each of said plurality of inspected data instances.

33. The method according to claim 32, wherein said procedure of classifying said at least one of said plurality of inspected data instances as an abnormal occurrence further includes the sub-procedures of:
producing a “pair distance versus unique identifier” graph according to said mapping; and
detecting when at least one data instance corresponds to an abnormal occurrence according to at least one peak of said “pair distance versus unique identifier” graph.

34. The method according to claim 30, further comprising the procedure of determining said unique identifier value difference ‘K’ such that the distance between said at least one of said plurality of inspected data instances from said respective K^{th} adjacent one of said plurality of inspected data instances being minimal.

35. The method according to claim 34, wherein said procedure of determining said unique identifier value difference ‘K’ includes the sub procedures of:
mapping between the distance, in said attribute space, and the difference in the value of said respective unique identifier between a selected one of said analyzed data instances and each of at least a portion of adjacent ones of said analyzed data instances; and
determining said unique identifier value difference ‘K’ as the difference in the value of said respective unique identifier corresponding to the minimal distance value.

36. The method according to claim 35, wherein said procedure of determining said unique identifier value difference ‘K’ further including the sub-procedures of:
updating said mapping according to at least one of said plurality of inspected data instances; and
re-determining said unique identifier value difference ‘K’ according to the updated said mapping.

37. The method of claim 30, further comprising the procedure of determining said distance threshold for K^{th} adjacency according to said analyzed data instances.

38. The method according to claim 37, wherein said procedure of determining said distance threshold for K^{th} adjacency includes the sub-procedures of:
mapping between a selected distance and the probability of being at said selected distance, in said attribute space, from a selected one of said analyzed data instances; and
determining said distance threshold for K^{th} adjacency according to the most probable distance value.

39. The method according to claim 38, wherein said procedure of determining said distance threshold for K^{th} adjacency further includes the sub-procedures of:
updating said mapping according to at least one of said plurality of inspected data instances; and
re-determining said distance threshold for K^{th} adjacency according to the updated said mapping.

40. The method according to claim 30, wherein each of said plurality of inspected data instances includes values associated with a selected set of said at least one physical attribute, said selected set of said at least one physical attribute being associated with a selected type of abnormal occurrence.

41. The method according to claim 17, wherein said abnormal occurrence detection method being employed for detecting abnormal events in a supply system, and wherein said inspected data instances being acquired by at least one sensor unit, each of said at least one sensor unit including at least one respective sensor, each of said at least one respective sensor measuring at least one respective one of said at least one physical attribute.
